(19) United States
(12) Patent Application Publication
(10) Pub. No.: US 2024/0221186 A1
(43) Pub. Date: Jul. 4, 2024

(54) PROCESSING FOR MACHINE LEARNING BASED OBJECT DETECTION USING SENSOR DATA

(71) Applicant: QUALCOMM Incorporated, San Diego, CA (US)

(72) Inventors: Makesh Pravin JOHN WILSON, San Diego, CA (US); Radhika Dilip GOWAIKAR, San Diego, CA (US); Shantanu Chaisson SANYAL, San Diego, CA (US); Avdhut JOSHI, San Marcos, CA (US); Rex JOMY JOSEPH, San Diego, CA (US); Volodimir SLOBODYANYUK, San Diego, CA (US)

(21) Appl. No.: 18/530,660

(22) Filed: Dec. 6, 2023

Related U.S. Application Data
(60) Provisional application No. 63/478,438, filed on Jan. 4, 2023.

(51) Int. Cl. G06T 7/246

(52) U.S. Cl. CPC G06T 7/251; G06T 2207/10028; G06T 2207/20084

(57) ABSTRACT

In some aspects, a device may obtain sensor data associated with identifying measured properties of an object in an environment. The device may detect a trigger event associated with at least one of the environment or the device. The device may modify, based on detecting the trigger event, one or more pre-processing operations associated with the sensor data for input to a neural network, and/or one or more post-processing operations associated with an object detection output of the neural network. The device may perform the one or more pre-processing operations associated with the sensor data to generate pre-processed sensor data. The device may generate the object detection output for the object based on detecting the object using the pre-processed sensor data as the input to the neural network. The device may perform the one or more post-processing operations using the object detection output. Numerous other aspects are described.

### CROSS-REFERENCE TO RELATED APPLICATION

This patent application claims priority to U.S. Provisional Patent Application No. 63/478,438, filed on Jan. 4, 2023, entitled “PROCESSING FOR MACHINE LEARNING BASED OBJECT DETECTION USING SENSOR DATA” and assigned to the assignee hereof. The disclosure of the prior application is considered part of and is incorporated by reference into this patent application.

### FIELD OF THE DISCLOSURE

Aspects of the present disclosure generally relate to sensor-based object detection and, for example, to processing for machine learning-based object detection using sensor data.

### BACKGROUND

Sensors, such as radar sensors, cameras, and/or light detection and ranging (LIDAR) sensors, among other examples, are often employed on devices or systems, such as vehicles, mobile devices (e.g., a mobile telephone, a mobile handset, a smart phone, and/or other mobile device), among other devices and systems. Such sensors can be used for many purposes. One example of using sensors is for enhanced vehicle safety, such as adaptive cruise control (ACC), forward collision warning (FCW), collision mitigation or avoidance via autonomous braking, pre-crash functions (e.g., airbag arming or pre-activation), and/or lane departure warning (LDW), among other examples. Systems that employ both radar and camera sensors can provide a high level of active safety capability and are increasingly available on production vehicles.

### SUMMARY

Some implementations described herein relate to a device. The device may include one or more memories and one or more processors coupled to the one or more memories. The one or more processors may be configured to obtain sensor data associated with identifying measured properties of at least one object in an environment. The one or more processors may be configured to detect a trigger event associated with at least one of the environment or the device. The one or more processors may be configured to modify, based at least in part on detecting the trigger event, at least one of: one or more pre-processing operations associated with the sensor data for input to a neural network, or one or more post-processing operations associated with an object detection output of the neural network. The one or more processors may be configured to perform the one or more pre-processing operations associated with the sensor data to generate pre-processed sensor data. The one or more processors may be configured to generate the object detection output for the at least one object based at least in part on detecting the at least one object using the pre-processed sensor data as the input to the neural network. The one or more processors may be configured to perform the one or more post-processing operations using the object detection output.

Some implementations described herein relate to a device. The device may include one or more memories and one or more processors coupled to the one or more memories. The one or more processors may be configured to obtain sensor data associated with identifying measured properties of at least one object in an environment, wherein the sensor data is associated with a sensor image having a first pixel size. The one or more processors may be configured to map data points indicated by the sensor data to a grid having a second pixel size. The one or more processors may be configured to generate an object detection output for the at least one object based at least in part on detecting the at least one object using the grid as input to a neural network.

Some implementations described herein relate to a method. The method may include obtaining, by a device, sensor data associated with identifying measured properties of at least one object in an environment. The method may include detecting, by the device, a trigger event associated with at least one of the environment or the device. The method may include modifying, by the device and based at least in part on detecting the trigger event, at least one of: one or more pre-processing operations associated with the sensor data for input to a neural network, or one or more post-processing operations associated with an object detection output of the neural network. The method may include performing, by the device, the one or more pre-processing operations associated with the sensor data to generate pre-processed sensor data. The method may include generating, by the device, the object detection output for the at least one object based at least in part on detecting the at least one object using the pre-processed sensor data as the input to the neural network. The method may include performing, by the device, the one or more post-processing operations using the object detection output.

Some implementations described herein relate to a method. The method may include obtaining, by a device, sensor data associated with identifying measured properties of at least one object in an environment, wherein the sensor data is associated with a sensor image having a first pixel size. The method may include mapping, by the device, data points indicated by the sensor data to a grid having a second pixel size. The method may include generating, by the device, an object detection output for the at least one object based at least in part on detecting the at least one object using the grid as input to a neural network.

Some implementations described herein relate to a non-transitory computer-readable medium that stores a set of instructions. The set of instructions, when executed by one or more processors of a device, may cause the device to obtain sensor data associated with identifying measured properties of at least one object in an environment. The set of instructions, when executed by one or more processors of the device, may cause the device to detect a trigger event associated with at least one of the environment or the device. The set of instructions, when executed by one or more processors of the device, may cause the device to modify, based at least in part on detecting the trigger event, at least one of: one or more pre-processing operations associated with the sensor data for input to a neural network, or one or more post-processing operations associated with an object detection output of the neural network. The set of instructions, when executed by one or more processors of the device, may cause the device to perform the one or more pre-processing operations associated with the sensor data to generate pre-processed sensor data. The set of instructions, when executed by one or more processors of the device, may cause the device to generate the object detection output for the at least one object based at least in part on detecting the at least one object using the pre-processed sensor data as the input to the neural network. The set of instructions, when executed by one or more processors of the device, may cause the device to perform the one or more post-processing operations using the object detection output.

Some implementations described herein relate to a non-transitory computer-readable medium that stores a set of instructions. The set of instructions, when executed by one or more processors of a device, may cause the device to obtain sensor data associated with identifying measured properties of at least one object in an environment, wherein the sensor data is associated with a sensor image having a first pixel size. The set of instructions, when executed by one or more processors of the device, may cause the device to map data points indicated by the sensor data to a grid having a second pixel size. The set of instructions, when executed by one or more processors of the device, may cause the device to generate an object detection output for the at least one object based at least in part on detecting the at least one object using the grid as input to a neural network.

Some implementations described herein relate to an apparatus. The apparatus may include means for obtaining sensor data associated with identifying measured properties of at least one object in an environment. The apparatus may include means for detecting a trigger event associated with at least one of the environment or the apparatus. The apparatus may include means for modifying, based at least in part on detecting the trigger event, at least one of: one or more pre-processing operations associated with the sensor data for input to a neural network, or one or more post-processing operations associated with an object detection output of the neural network. The apparatus may include means for performing the one or more pre-processing operations associated with the sensor data to generate pre-processed sensor data. The apparatus may include means for generating the object detection output for the at least one object based at least in part on detecting the at least one object using the pre-processed sensor data as the input to the neural network. The apparatus may include means for performing the one or more post-processing operations using the object detection output.

Some implementations described herein relate to an apparatus. The apparatus may include means for obtaining sensor data associated with identifying measured properties of at least one object in an environment, wherein the sensor data is associated with a sensor image having a first pixel size. The apparatus may include means for mapping data points indicated by the sensor data to a grid having a second pixel size. The apparatus may include means for generating an object detection output for the at least one object based at least in part on detecting the at least one object using the grid as input to a neural network.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram of an example environment in which systems and/or methods described herein may be implemented, in accordance with the present disclosure.

FIG. 2 is a diagram illustrating example components of a device, in accordance with the present disclosure.

FIGS. 3A-3C are diagrams illustrating an example associated with a sensor object detection system for detecting objects from sensor information, in accordance with the present disclosure.

FIGS. 4A and 4B are diagrams of an example associated with processing for machine learning-based object detection using sensor data, in accordance with the present disclosure.

FIG. 5 is a diagram of an example associated with the deep learning model, in accordance with the present disclosure.

FIG. 6 is a flowchart of an example process associated with processing for machine learning-based object detection using sensor data.

FIG. 7 is a flowchart of an example process associated with processing for machine learning-based object detection using sensor data.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

A vehicle may include a system (e.g., an electronic control unit (ECU), and/or an autonomous driving system) configured to control an operation of the vehicle. The system may use data obtained by one or more sensors of the vehicle to perform occupancy mapping to determine an occupancy status (e.g., unoccupied space, occupied space, and/or drivable space) of the environment surrounding the vehicle. For example, the system may use data obtained by a global navigation satellite system (GNSS)/inertial measurement unit (IMU), a camera, a light detection and ranging (LIDAR) scanner, and/or a radar scanner, among other examples, to determine an occupancy status of the environment surrounding the vehicle. The system may detect drivable space that the vehicle can occupy based on the occupancy status of the environment surrounding the vehicle. The system may be configured to identify, in real-time, the occupancy status of the environment surrounding the vehicle and to determine a drivable space that the vehicle is able to occupy based on the occupancy status of the environment. To perform occupancy and free space detection when using a sensor configured to obtain point data of an object (e.g., a radar sensor, a LIDAR sensor, and/or a camera), the system may subdivide an area of interest (e.g., an area surrounding the vehicle) into a number of uniformly spaced square grids (e.g., occupancy grids).

For example, the GNSS/IMU may provide data indicating a position of the vehicle in the environment. The system may couple the data obtained by the GNSS/IMU with a high resolution map to determine an exact location of the vehicle on the map, and may use the map to estimate the occupancy status of the environment surrounding the vehicle and/or to estimate drivable space within the environment. However, the map may not include information associated with recent changes to the environment. For example, the map may not include information associated with construction being performed on a roadway, other vehicles traveling along the roadway, and/or objects, people, and/or animals, among other examples, located on or adjacent to the roadway, among other examples.

Radar sensors, camera sensors, an/or other types of sensors may be used by devices or systems (e.g., vehicles, mobile devices, and/or extended realty systems) for various purposes. For example, vehicles may make use of radar and camera sensors for enhanced vehicle safety, such as adaptive cruise control (ACC), forward collision warning (FCW), collision mitigation or avoidance (e.g., via autonomous braking), pre-crash functions (e.g., airbag arming or pre-activation), and/or lane departure warning (LDW), among other examples. For example, one or more camera sensors mounted on a vehicle can be used to capture images of an environment surrounding the vehicle (e.g., in front of the vehicle, behind the vehicle, and/or to the sides of the vehicle). A processor within the vehicle (e.g., a digital signal processor (DSP) or other processor) can attempt to identify objects within the captured images. Such objects may be other vehicles, pedestrians, road signs, objects within the road of travel, and/or other types of objects. Radar systems may also be used to detect objects along the road of travel of the vehicle. For example, a radar system can include one or more sensors that utilize electromagnetic waves to determine information related to the objects, such as the location or range, altitude, direction, and/or speed of the objects along the road.

A radar system may include one or more transmitters that transmit electromagnetic waves in the radio or microwaves domain toward objects in the environment surrounding the vehicle. The electromagnetic waves may reflect off surfaces in the environment and one or more receivers of the radar scanner may be configured to receive the reflections of the electromagnetic waves. The reflected signals may be processed to provide the information related to the objects within the environment such as a location of the object and speed of the object. A radar system may output frames (or images) at a specific interval, such as 10 Hertz (Hz). The frames may be used to identify the objects in the environment. In some cases, the images may include a collection of points (e.g., a point cloud). For example, each point may indicate or represent a reflection of an electromagnetic signal from a potential object in the environment around the radar system.

Radar systems may output instantaneous data, tracked data, or a combination of instantaneous data and tracked data. Instantaneous data may include data that is identified by a reflected signal at one point in time. For example, instantaneous data may include a location of the object, a signal-to-noise ratio (SNR) of the signal, a radar cross section (RCS), and/or other data. Radar systems may also track data (referred to as tracked data) by measuring the object at different times, such as by sending electromagnetic signals at two different times and identifying differences in the reflected signals. In some examples, the tracked data from a radar system may include velocity, acceleration, yaw, and/or other data. In some cases, radar systems can provide object information such as length, width, and/or height, among other examples.

Object detection systems and methods can be used to identify regions (e.g., in one or more images) that correspond to an object. Regions identified by an object detection system may be represented as a bounding region (e.g., a bounding box or another region) that fits around a perimeter of a detected object, such as a vehicle, road sign, pedestrian, and/or another object. In some cases, a bounding region from the object detection system can be used by another component or system to perform a function based on a position of that bounding region. For example, a bounding region may be input into a vehicle blind spot detector to identify the presence of an object in a blind spot that the vehicle operator is unable to safely perceive.

An object detection system that is configured to detect objects in radar images may output erroneous detection results, such as due to output information from a radar system not being able to identify one or more edges of a particular object. For example, the transmitted electromagnetic waves from the radar system will not be incident on each surface of the object. Because each surface will not reflect the electromagnetic waves, the radar output will identify some, but not all, surfaces of the object. Further, objects in the environment can vary in size, which may affect the confidence of the object detection based on fewer points associated with some objects. As a result, in some cases, a machine learning-based approach for object detection based on sensor (e.g., radar) data may be used.

For example, one or more frames or images generated by a sensor (e.g., a radar scanner or radar system), as described above, may be input to a machine learning or a deep learning model. The model may be trained to output bounding regions (e.g., bounding boxed) around detected objects based on one or more sensor frames or sensor images. However, in some cases, the machine learning-based approach may result in inaccurate results. For example, if there are many objects in an environment around a sensor system (e.g., around a vehicle) that are frequently changing velocities (e.g., changing from stationary or stopped to moving), then the machine learning-based approach may fail to detect one or more objects indicated by one or more sensor frames or sensor images. For example, in stop-and-go traffic scenarios (e.g., where vehicles in an environment are frequently changing from stationary or stopped to in motion or moving) the machine learning-based approach may fail to detect one or more objects indicated by one or more sensor frames or sensor images because the machine learning model may be trained based on moving vehicles in the environment (e.g., a combination of moving and stopped vehicles may cause the machine learning model to fail to detect one or more vehicles).

Some implementations described herein enable processing for machine learning-based object detection using sensor data. For example, the sensor data may include radar data, LIDAR data, and/or camera data. For example, a system (e.g., an ECU of a vehicle) may be configured to perform one or more pre-processing operations and/or one or more post-processing operations associated with an input to a machine learning model and/or associated with an output of the machine learning model. For example, the system may obtain sensor data associated with identifying measured properties of at least one object in an environment. The sensor data may be associated with a sensor image having a first pixel size. The system may map data points indicated by the sensor data to a grid having a second pixel size. The system may generate an object detection output for the at least one object based on detecting the at least one object using the grid as input to a machine learning model. In other words, the system may be configured to modify a pixel size and/or a grid size of an input to the machine learning model to improve object detect results. For example, using a larger grid size may improve the accuracy of object detections of the machine learning model because a larger pixel size (or grid size) may improve the machine learning model's ability to detect stopped or stationary objects located proximate to the system.

As another example, the object detection output of the machine learning model may include a bounding region that identifies a location of an object that is not associated with an object indication as indicated by the sensor data. In other words, the modified pre-processing and/or post-processing operations may result in a detected object that is not associated with an object as indicated by the sensor data. As a result, the sensor data may not indicate property values (e.g., velocity, acceleration, RCS, and/or other property values) of the object because the sensor system may not have detected the object. Therefore, the system may determine one or more property values associated with the object based at least in part on property values of point cloud data associated with the location as indicated by the sensor data and/or property values of one or more other objects indicated by the sensor data, among other examples. In other words, the system may use a combination of point clouds and tracked objects to compute one or more property values associated with the object. As another example, the modified pre-processing and/or post-processing operations may include modifying a classification confidence score of the object detection output based on the location of an object not being associated with the object indication (e.g., indicated by the sensor data).

In some aspects, the system may modify the pre-processing and/or post-processing operations performed by the system based at least in part on detecting a trigger event. For example, the pre-processing and/or post-processing operations described herein may consume processing resources and/or computing resources associated with performing the pre-processing and/or post-processing operations. Therefore, performing the pre-processing and/or post-processing operations in certain scenarios (e.g., where the pre-processing and/or post-processing operations may not improve an output of the machine learning model and/or may actually degrade the output of the machine learning model) may needlessly consume the processing resources and/or computing resources associated with performing the pre-processing and/or post-processing operations. Therefore, the system may modify, based on detecting a trigger event, one or more pre-processing operations associated with the sensor data for input to the machine learning model, and/or one or more post-processing operations associated with an object detection output of the machine learning model. Modifying the pre-processing and/or post-processing operations may include changing operations that are performed, performing one or more additional operation(s), and/or refraining from performing one or more operations, among other examples. In some aspects, the trigger event may be based at least in part on a velocity associated with the device, a sensor type or sensor configuration associated with the sensor data, a vehicle type, and/or a quantity of objects detected in the environment, among other examples.

As a result, an accuracy of an object detection output of a machine learning model is improved in certain scenarios, such as in stop-and-go traffic scenarios. For example, performing the one or more modified pre-processing operations and/or post-processing operations may improve the machine learning model's ability to detect objects in the certain scenarios. Additionally, by selectively performing the one or more modified pre-processing operations and/or post-processing operations based on detecting a trigger event, processing resources and/or computing resources are conserved that would have otherwise been used associated with performing the pre-processing and/or post-processing operations in scenarios where the pre-processing and/or post-processing operations may not improve an output of the machine learning model and/or may actually degrade the output of the machine learning model.

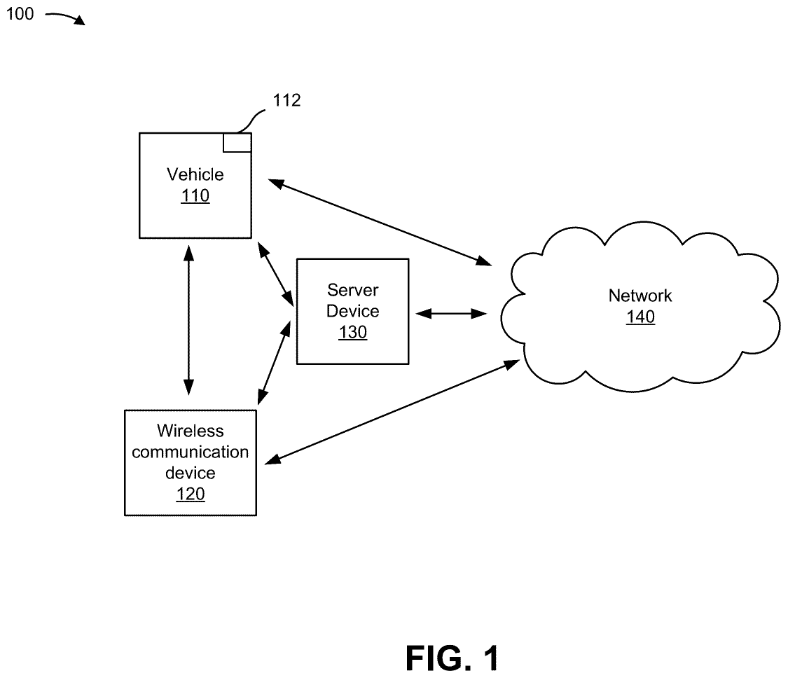

FIG. 1 is a diagram of an example environment 100 in which systems and/or methods described herein may be implemented, in accordance with the present disclosure. As shown in FIG. 1, environment 100 may include a vehicle 110 that includes an ECU 112, a wireless communication device 120, a server device 130, and a network 140. Devices of environment 100 may interconnect via wired connections, wireless connections, or a combination of wired and wireless connections.

The vehicle 110 may include any vehicle that is capable of transmitting and/or receiving data associated with processing for machine learning-based object detection using camera data, radar data, and/or LIDAR data, among other examples, as described herein. For example, the vehicle 110 may be a consumer vehicle, an industrial vehicle, and/or a commercial vehicle, among other examples. The vehicle 110 may be capable of traveling and/or providing transportation via public roadways, and/or may be capable of use in operations associated with a worksite (e.g., a construction site), among other examples. The vehicle 110 may include a sensor system that includes one or more sensors that are used to generate and/or provide vehicle data associated with vehicle 110 and/or a radar scanner and/or a LIDAR scanner that is used to obtain point data used for road scene understanding in autonomous driving.

The vehicle 110 may be controlled by the ECU 112, which may include one or more devices capable of receiving, generating, storing, processing, and/or providing information associated with occupancy clustering according to point data (e.g., data obtained by a radar scanner, a LIDAR scanner, and/or a camera) and/or road scene understanding described herein. For example, the ECU 112 may be associated with an autonomous driving system and/or may include and/or be a component of a communication and/or computing device, such as an onboard computer, a control console, an operator station, or a similar type of device. The ECU 112 may be configured to communicate with an autonomous driving system of the vehicle 110, ECUs of other vehicles, and/or other devices. For example, advances in communication technologies have enabled vehicle-to-everything (V2X) communication, which may include vehicle-to-vehicle (V2V) communication, and/or vehicle-to-pedestrian (V2P) communication, among other examples. In some aspects, the ECU 112 may receive vehicle data associated with the vehicle 110 (e.g., location information, sensor data, radar data, and/or LIDAR data) and perform machine learning-based occupancy grid generation to determine the occupancy status of the environment surrounding the vehicle 110 and to determine a drivable space that the vehicle is able to occupy based on the occupancy status of the environment based on the vehicle data, as described herein.

The wireless communication device 120 includes one or more devices capable of receiving, generating, storing, processing, and/or providing information associated with processing for machine learning-based object detection using sensor data, as described elsewhere herein. For example, the wireless communication device 120 may include a base station, and/or an access point, among other examples. Additionally, or alternatively, the wireless communication device 120 may include a communication and/or computing device, such as a mobile phone (e.g., a smart phone, and/or a radiotelephone), a laptop computer, a tablet computer, a handheld computer, a desktop computer, a gaming device, a wearable communication device (e.g., a smart wristwatch, and/or a pair of smart eyeglasses), and/or a similar type of device.

The server device 130 may include one or more devices capable of receiving, generating, storing, processing, providing, and/or routing information associated with processing for machine learning-based object detection using sensor data, as described elsewhere herein. The server device 130 may include a communication device and/or a computing device. For example, the server device 130 may include a server, such as an application server, a client server, a web server, a database server, a host server, a proxy server, a virtual server (e.g., executing on computing hardware), or a server in a cloud computing system. In some aspects, the server device 130 may include computing hardware used in a cloud computing environment. In some aspects, the server device 130 may include one or more devices capable of training a machine learning model or a deep learning model associated with object detection, as described in more detail elsewhere herein.

The network 140 includes one or more wired and/or wireless networks. For example, the network 140 may include a peer-to-peer (P2P) network, a cellular network (e.g., a long-term evolution (LTE) network, a code division multiple access (CDMA) network, an open radio access network (O-RAN), a New Radio (NR) network, a 3G network, a 4G network, a 5G network, or another type of next generation network), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a cloud computing network, among other examples, and/or a combination of these or other types of networks. In some aspects, the network 140 may include and/or be a P2P communication link that is directly between one or more of the devices of environment 100.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

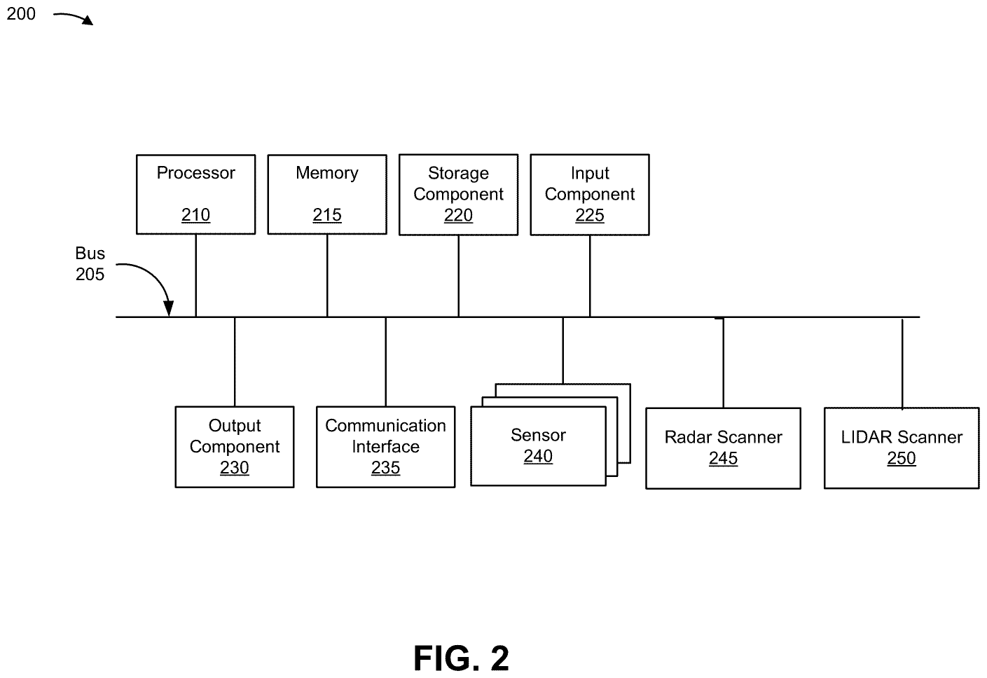

FIG. 2 is a diagram illustrating example components of a device 200, in accordance with the present disclosure. Device 200 may correspond to the vehicle 110, the ECU 112, the wireless communication device 120, and/or the server device 130. In some aspects, the vehicle 110, the ECU 112, the wireless communication device 120, and/or the server device 130 may include one or more devices 200 and/or one or more components of device 200. As shown in FIG. 2, device 200 may include a bus 205, a processor 210, a memory 215, a storage component 220, an input component 225, an output component 230, a communication interface 235, one or more sensors 240, a radar scanner 245, and/or a LIDAR scanner 250.

Bus 205 includes a component that permits communication among the components of device 200. Processor 210 is implemented in hardware, firmware, or a combination of hardware and software. Processor 210 is a central processing unit (CPU), a graphics processing unit (GPU), an accelerated processing unit (APU), a microprocessor, a microcontroller, a DSP, a field-programmable gate array (FPGA), an application-specific integrated circuit (ASIC), or another type of processing component. In some aspects, processor 210 includes one or more processors capable of being programmed to perform a function. Memory 215 includes a random access memory (RAM), a read only memory (ROM), and/or another type of dynamic or static storage device (e.g., a flash memory, a magnetic memory, and/or an optical memory) that stores information and/or instructions for use by processor 210.

Storage component 220 stores information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 includes a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., a global positioning system (GPS) component or a GNSS component) and/or a sensor for sensing information (e.g., an accelerometer, a gyroscope, an actuator, or another type of position or environment sensor). Output component 230 includes a component that provides output information from device 200 (e.g., a display, a speaker, a haptic feedback component, and/or an audio or visual indicator).

Communication interface 235 includes a transceiver-like component (e.g., a transceiver and/or a separate receiver and transmitter) that enables device 200 to communicate with other devices, such as via a wired connection, a wireless connection, or a combination of wired and wireless connections. Communication interface 235 may permit device 200 to receive information from another device and/or provide information to another device. For example, communication interface 235 may include an Ethernet interface, an optical interface, a coaxial interface, an infrared interface, a radio frequency interface, a universal serial bus (USB) interface, a wireless local area interface (e.g., a Wi-Fi interface), and/or a cellular network interface.

The one or more sensors 240 may include one or more devices capable of sensing characteristics associated with the device 200. A sensor 240 may include one or more integrated circuits (e.g., on a packaged silicon die) and/or one or more passive components of one or more flex circuits to enable communication with one or more components of the device 200. The sensor 240 may include an optical sensor that has a field of view in which the sensor 240 may determine one or more characteristics of an environment of the device 200. In some aspects, the sensor 240 may include a camera. For example, the sensor 240 may include a low-resolution camera (e.g., a video graphics array (VGA)) that is capable of capturing images that are less than one megapixel or images that are less than 1216×912 pixels, among other examples. The sensor 240 may be a low-power device (e.g., a device that consumes less than ten milliwatts (mW) of power) that has always-on capability while the device 200 is powered on. Additionally, or alternatively, a sensor 240 may include magnetometer (e.g., a Hall effect sensor, an anisotropic magneto-resistive (AMR) sensor, and/or a giant magneto-resistive sensor (GMR)), a location sensor (e.g., a GPS receiver and/or a local positioning system (LPS) device (e.g., that uses triangulation and/or multi-lateration)), a gyroscope (e.g., a micro-electro-mechanical systems (MEEMS) gyroscope or a similar type of device), an accelerometer, a speed sensor, a motion sensor, an infrared sensor, a temperature sensor, and/or a pressure sensor, among other examples.

The radar scanner 245 may include one or more devices that use radio waves to determine the range, angle, and/or velocity of an object based on radar data obtained by the radar scanner 245. The radar scanner 245 may provide the radar data to the ECU 112 to enable the ECU 112 to perform machine learning-based occupancy grid generation according to the radar data, as described herein.

The LIDAR scanner 250 may include one or more devices that use light in the form of a pulsed laser to measure distances of objects from the LIDAR scanner based on LIDAR data obtained by the LIDAR scanner 250. The LIDAR scanner 250 may provide the LIDAR data to the ECU 112 to enable the ECU 112 to perform machine learning-based occupancy grid generation according to the LIDAR data, as described herein.

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication interface 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

In some aspects, device 200 may include means for obtaining sensor data associated with identifying measured properties of at least one object in an environment; means for detecting a trigger event associated with at least one of the environment or the device; means for modifying, based at least in part on detecting the trigger event, at least one of: one or more pre-processing operations associated with the sensor data for input to a neural network, or one or more post-processing operations associated with an object detection output of the neural network; means for performing the one or more pre-processing operations associated with the sensor data to generate pre-processed sensor data; means for generating the object detection output for the at least one object based on detecting the at least one object using the pre-processed sensor data as the input to the neural network; and/or means for performing the one or more post-processing operations using the object detection output. In some aspects, device 200 may include means for obtaining sensor data associated with identifying measured properties of at least one object in an environment, wherein the sensor data is associated with a sensor image having a first pixel size; means for mapping data points indicated by the sensor data to a grid having a second pixel size; and/or means for generating an object detection output for the at least one object based on detecting the at least one object using the grid as input to a neural network. In some aspects, the means for device 200 to perform processes and/or operations described herein may include one or more components of device 200 described in connection with FIG. 2, such as bus 205, processor 210, memory 215, storage component 220, input component 225, output component 230, communication interface 235, the one or more sensors 240, the radar scanner 245, and/or the LIDAR scanner 250.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

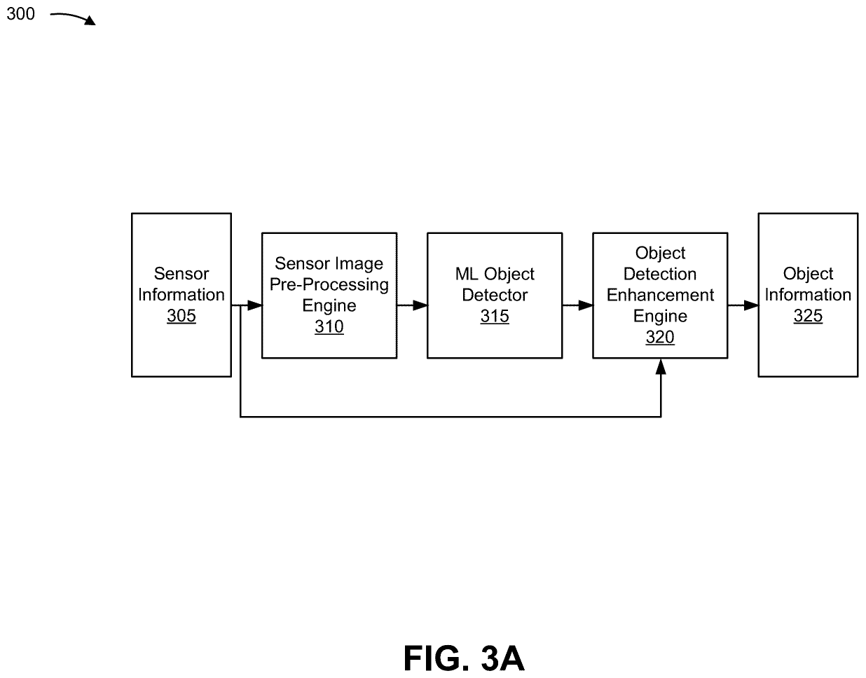

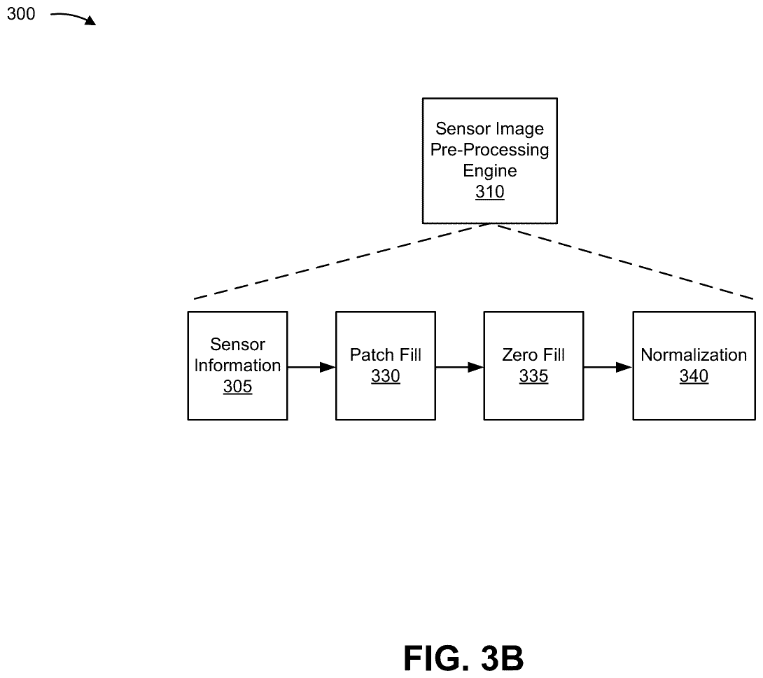

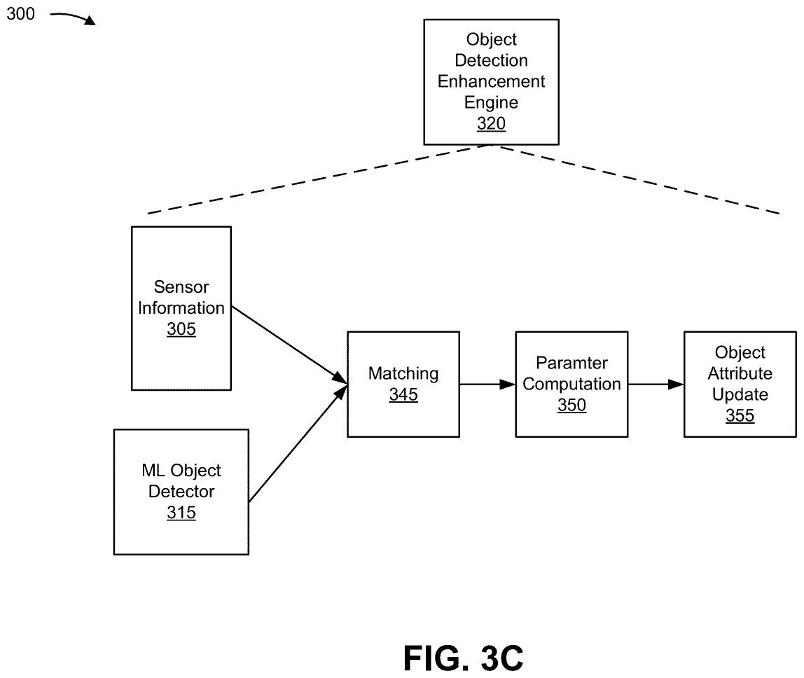

FIGS. 3A-3C are diagrams illustrating an example associated with a sensor object detection system 300 for detecting objects from sensor information 305, in accordance with the present disclosure. The sensor object detection system 300 may include a sensor image pre-processing engine 310, a machine learning (ML) object detector 315, and an object detection enhancement engine 320. While the sensor object detection system 300 is shown to include certain components, the sensor object detection system 300 can include more or fewer (and/or different) components than those shown in FIG. 3. For example, the sensor object detection system 300 may include one or more components or devices described and depicted elsewhere herein, such as in connection with FIGS. 1 and 2.

In some examples, the sensor information 305 is output from a sensor system that is separate from the sensor object detection system 300, such as from the one or more sensors 240, the radar scanner 245, and/or the LIDAR scanner 250, among other examples. For example, the sensor information 305 may include radar data, LIDAR data, and/or camera data, among other examples. In some examples, the sensor information 305 may be detected by the sensor object detection system 300. In some examples, the sensor information 305 may be a sensor image (or frame) that includes a plurality of points (e.g., a point cloud), with each point indicating a signal reflected from that point and measurements of that point (e.g., location, velocity, SNR, RCS, etc.). In some cases, the sensor image (or frame) may visually depict an intensity of electromagnetic reflections from objects in the environment. In some examples, the sensor image (or frame) may include a list of objects including attributes for each object, such as intensity, SNR, length, width, and/or yaw, among other examples. In some examples, the sensor information 305 may include multiple sensor images (or frames).

In some examples, a point cloud data may be a collection of individual points within the environment that identify a measured parameter of objects within the environment. In the example of a sensor fixed on a vehicle to perform object detection, the detected objects may include other vehicles, road signs, vegetation, building, pedestrians, and/or other objects. Each of these objects may be present within a sensor image and have an RCS value that identifies an intensity of the electromagnetic reflection that can be used to identify objects of interest. For example, different surfaces of objects may have a magnetic permeability and may absorb some of the electromagnetic waves to reduce the intensity of the reflection.

The sensor object detection system 300 may input the sensor information 305 (e.g., a sensor image or multiple sensor images) into the sensor image pre-processing engine 310. In some examples, the sensor image pre-processing engine 310 may be configured to pre-process the sensor information 305 into pre-processed sensor information (e.g., a pre-processed sensor image or multiple pre-processed sensor images) for input into the ML object detector 315. In some aspects, the sensor image pre-processing engine 310 may pre-process the sensor information 305 into pre-processed sensor information based on the expected input for the ML object detector 315. For example, the sensor image pre-processing engine 310 can quantize and map point cloud data from the sensor information 305 into a pre-processed radar image with each pixel of the radar image representing a parameter or property. In some aspects, the sensor image pre-processing engine 310 can identify pixels in the pre-processed radar image that are associated with a point in the point cloud from the sensor information 305 and insert a value into each pixel based on at least one measured parameter or property from the radar image (e.g., a RCS, a velocity, an SNR, and/or yaw). Pixels that are not associated with a point in the point cloud may include a default value that is determined by the sensor image pre-processing engine 310.

In some examples, the sensor information 305 may include one or more sensor images (as noted above) and one or more bounding regions (e.g., a bounding box, a bounding ellipse, a bounding square, and/or other bounding region) that identify pixels in the one or more sensor images that correspond to respective objects. A bounding box may be used herein as an illustrative example of a bounding region. In some examples, the sensor image pre-processing engine 310 may improve the quality of the predictions provided by the ML object detector 315 by modifying the one or more sensor images. For example, the sensor image pre-processing engine 310 may identify points in a sensor image that correspond to continuous edges of an object. After identifying points that correspond to continuous edges, the sensor image pre-processing engine 310 may determine a point associated with the continuous edges that forms a two-dimensional (2D) patch within the radar image based on the continuous edges. In some aspects, the sensor image pre-processing engine 310 may be configured to determine one or more points with the continuous edges that form a three-dimensional (3D) patch (e.g., associated with a 3D dataset such as a voxel) or other multi-dimensional patch. For example, the sensor image pre-processing engine 310 may be configured to identify volumes associated with objects from 3D point cloud data from a LIDAR scanner.

As shown in FIG. 3B, the sensor image pre-processing engine 310 may then modify the sensor image based on the 2D patch. For example, as shown by reference number 330, the sensor image pre-processing engine 310 may identify pixels within the 2D patch and fill each identified pixel with a value. In some aspects, the sensor image pre-processing engine 310 may determine the value based on the sensor information 305. In some cases, the sensor image pre-processing engine 310 may determine a default value for pixels in the pre-processed radar image that do not include a measured property or parameter (e.g., a measured SNR, a measured RCS, and/or another measured parameter) and may insert the default value for each of the pixels that do not include a measured property or parameter. For example, as shown by reference number 335, the sensor image pre-processing engine 310 may fill each identified pixel that does not include a measured property or parameter with a value of zero (e.g., zero fill). For example, the default value may be zero. As shown by reference number 340, the sensor image pre-processing engine 310 may normalize the pre-processed sensor image(s). For example, pixels having a value (e.g., pixels not having a null or undefined value) can be normalized to a minimum value (e.g., 0 or −1) and a maximum value (e.g., 1) to more clearly identify the relationships of the points.

Returning to FIG. 3A, the pre-processed radar information (e.g., the one or more pre-processed sensor images) may be input into the ML object detector 315. The ML object detector 315 may be a machine learning based (e.g., using one or more neural networks) object detector trained to perform specific tasks. In some aspects, the ML object detector 315 may be trained to identify regions from the pre-processed sensor image data that correspond to one or more objects and to output object detection information representing the one or more objects. The object detection information may include a connected space that includes a plurality of points and a path between each point. In some aspects, a simply connected space may include a bounding region (e.g., a bounding box, a bounding ellipse, a bounding square, a closed polygon, or other bounding region) that forms a boundary representing an object detected by the ML object detector 315. In some aspects, the object detection information can additionally include a classification, such as a type of object, and a classification confidence that indicates the quality of the object classification.

The ML object detector 315 can implement “deep learning” techniques, such as ML or artificial intelligence (AI) methods based on learning data representations, as opposed to task-specific algorithms, which can perform specific functions that are difficult to implement using pure logic approaches. In some aspects, the ML object detector 315 may include a deep neural network (DNN), which is a type of artificial neural network (ANN) having multiple hidden layers between the input and output layer that can be trained to perform a specific function such as detecting, classifying, locating, and understanding objects in sensor information 305 (e.g., a pre-processed version of a sensor image), such as radar information output from a radar scanner. For example, a DNN may perform mathematical operations in the hidden layers to calculate the probability of a particular output from a given input. For example, a DNN that is trained to recognize types of objects that may be encountered by an autonomous or semi-autonomous vehicle will analyze a given sensor image and calculate the probability that each object detected in the frame is a vehicle, a pedestrian, a road sign, and/or another type of object. As another example, the ML object detector 315 may include a convolutional neural network (CNN). A CNN may be a type of DNN that implements regularized versions of multilayer perceptrons, which may be fully connected networks with each neuron in one layer being connected to all neurons in the next layer.

The object detection enhancement engine 320 may receive or obtain, (e.g., from memory or directly) from the ML object detector 315, the object detection information and the sensor information 305. The object detection enhancement engine 320 may determine object information 325. The object information 325 may include object detection results (e.g., bounding regions, classification information, and/or classification confidence) and/or properties or attributes of detected objects. In some aspects, the object detection enhancement engine 320 may process the object detection information from the ML object detector 315 and the sensor information 305 to improve object detection results and/or make other enhancements. In some examples, the object detection enhancement engine 320 may be configured to map a bounding region from the object detection information onto the sensor information 305 (e.g., onto one or more sensor images) to improve the object detection results, to improve measured properties of an object within a bounding region, and/or make other improvements. In one example, the object detection enhancement engine 320 may identify points in the sensor information 305 that are within the bounding region and calculate a property of that object based on the identified points. Additionally, or alternatively, the object detection enhancement engine 320 may filter out object detection results that do not correspond to any object identified in the sensor information 305.

As shown in FIG. 3C, and by reference number 345, the object detection enhancement engine 320 may perform matching of objects with default boxes of different aspect ratios. For example, any default box with an intersection-over-union with a ground truth box over a threshold (e.g., 0.4, 0.5, 0.6, or other suitable threshold) may be considered a match for the object. As shown by reference number 350, the object detection enhancement engine 320 may calculate a parameter or a property for a detected object. For example, the object detection enhancement engine 320 may calculate parameters or properties (or representative parameters or properties, such as an average or mean, maximum, a median, a trimmed mean, or any combination or variation thereof), of selected points from the sensor information 305 (e.g., points that are within a bounding region indicated by the ML object detector 315 for an object). A trimmed mean may include a mean that is calculated based on discarding or ignoring a certain percentile, such as a top 5 percentile and bottom 5 percentile, and computing the mean of the remaining values. As shown by reference number 355, the object detection enhancement engine 320 may update one or more attributes of detected object(s). For example, the object detection enhancement engine 320 may associate the calculated parameters or properties of an object with a bounding box (e.g., that is output by the ML object detector 315) for the object.

In some aspects, the object detection enhancement engine 320 may generate and output the object information 325 based on the properties of one or more objects to another function. In one example, the object detection enhancement engine 320 may provide the object information 325 for location-based functions. For example, a location-based function may a control system (e.g., the ECU 112) of an autonomous vehicle (e.g., the vehicle 110) that uses the object information 325 to plan the movement of the autonomous vehicle in the environment of the autonomous vehicle. An autonomous vehicle is provided as an example of a device that may benefit from the enhanced object detection based on sensor data that is described herein. For example, the enhanced object detection based on sensor data can be implemented in a variety of other functions such as detecting objects beneath objects within other objects (e.g., surface or ground penetrating radar).

As described elsewhere herein, the object information 325 may include inaccurate results. For example, if there are many objects in an environment around a sensor system (e.g., around a vehicle) that are frequently changing velocities (e.g., changing from stationary or stopped to moving), then the object information 325 may not include one or more objects indicated by one or more sensor frames or sensor images. For example, in stop-and-go traffic scenarios (e.g., where vehicles in an environment are frequently changing from stationary or stopped to in motion or moving), the ML object detector 315 and/or the object detection enhancement engine 320 may fail to detect one or more objects indicated by one or more sensor frames or sensor images because the machine learning model may be trained based on moving vehicles in the environment (e.g., a combination of moving and stopped vehicles may cause the machine learning model to fail to detect one or more vehicles).

As indicated above, FIGS. 3A-3C are provided as examples. Other examples may differ from what is described with respect to FIGS. 3A-3C.

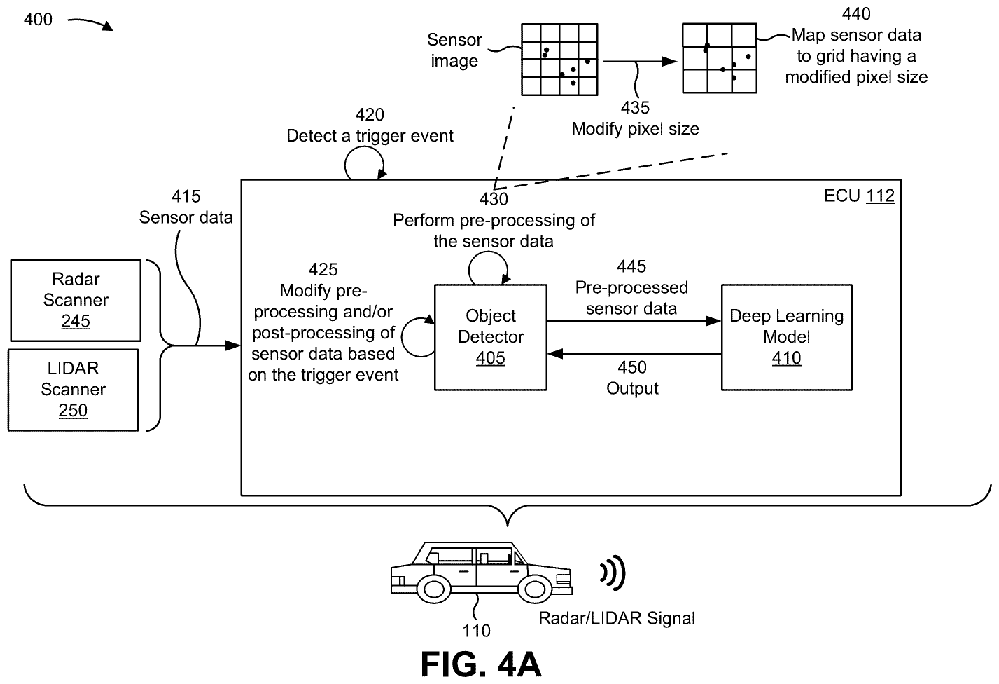

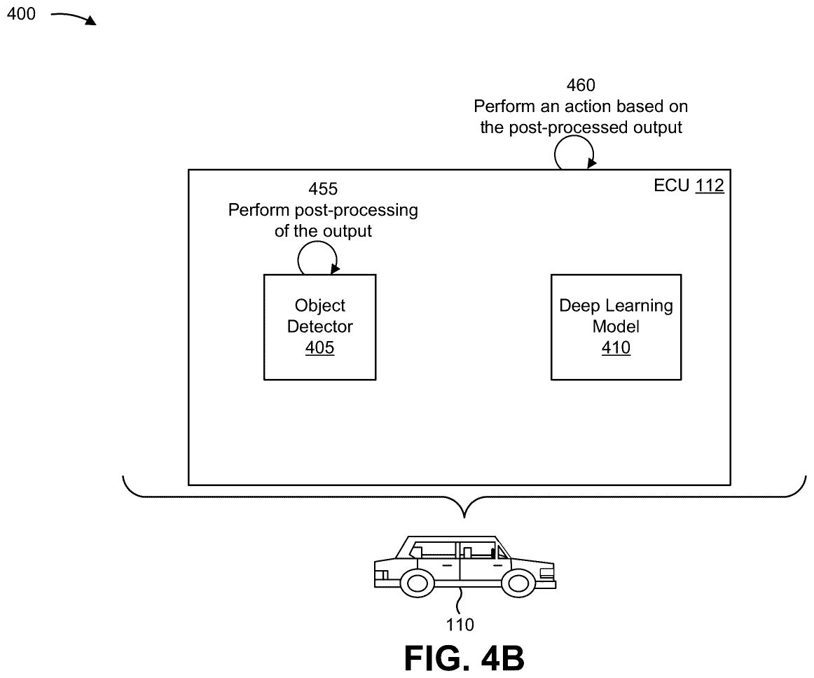

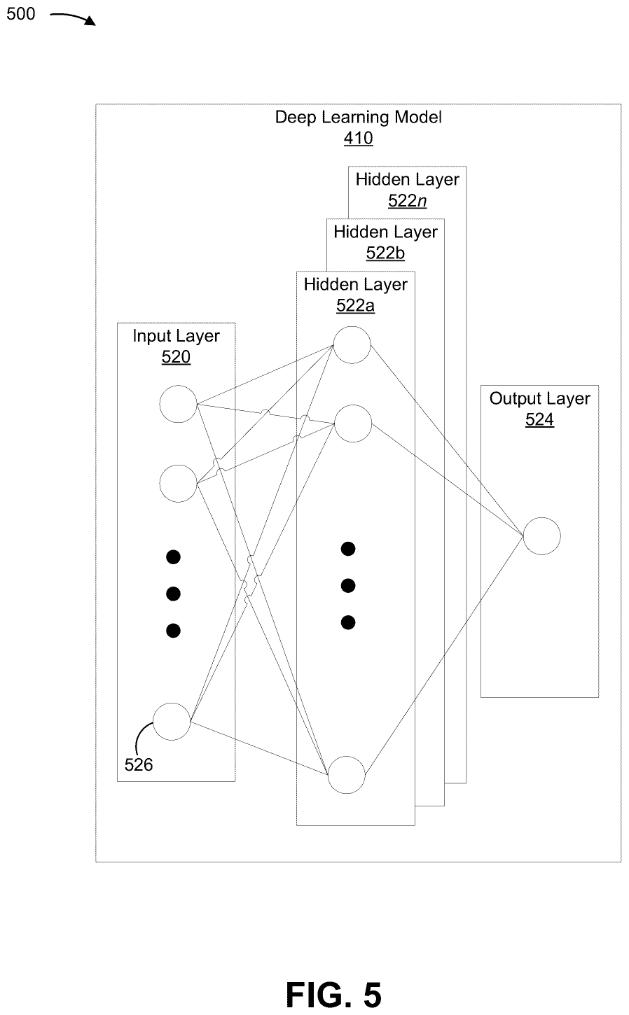

FIGS. 4A and 4B are diagrams of an example 400 associated with processing for machine learning-based object detection using sensor data, in accordance with the present disclosure. As shown in FIGS. 4A and 4B, example 400 includes the vehicle 110 and the ECU 112. These devices are described in more detail below in connection with FIG. 1 and FIG. 2. As shown in FIGS. 4A and 4B, the vehicle 110 and/or the ECU 112 may include an object detector 405 and a deep learning model 410. The object detector 405 may include, or may be similar to, the ML object detector 315 and/or the object detection enhancement engine 320. The deep learning model 410 may include a neural network. The deep learning model 410 is described in more detail in connection with FIG. 5. The vehicle 110 and the ECU 112 are provided as example devices that may utilize machine learning-based object detection using sensor data. In other examples, another device (e.g., an aircraft, a train, a navigational device, a mapping device, and/or another type of device) may obtain and/or analyze sensor data (e.g., radar data) for machine learning-based object detection using the sensor data in a similar manner as described herein.

The object detector 405 may be a component of the vehicle 110 and/or of the ECU 112 that is configured to generate object detection based on an output of the deep learning model 410. In some aspects, the vehicle 110 and/or the ECU 112 may obtain the deep learning model 410 (e.g., after the deep learning model 410 is trained). For example, the vehicle 110 and/or the ECU 112 may obtain the deep learning model 410 from the server device 130 (e.g., the vehicle 110 and/or the ECU 112 may download the trained deep learning model 410 from the server device 130). In some aspects, the deep learning model 410 may be trained (e.g., offline) by the server device 130. In some aspects, the vehicle 110 and/or the ECU 112 may not obtain the deep learning model 410. For example, the deep learning model 410 may be maintained by another device, such as the server device 130. The vehicle 110 and/or the ECU 112 may provide data (e.g., data associated with an aggregated frame) to the other device. The other device may input the data into the deep learning model 410. In such examples, the other device (e.g., the server device 130) may transmit, and the vehicle 110 and/or the ECU 112 may receive, an output of the deep learning model 410.

In some aspects, the deep learning model 410 may be trained to recognize one or more scenarios, such as a stop-and-go traffic scenario. For example, a device (e.g., the server device 130 and/or another device training the deep learning model 410) may train the deep learning model by oversampling training data associated with the one or more scenarios. Oversampling training data may include randomly selecting data points associated with the one or more scenarios and duplicating the data points to increase the quantity of data points associated with the one or more scenarios in the training data. This improves the ability of the deep learning model 410 to recognize the one or more scenarios and/or to more accurately detect objects in the one or more scenarios.

As shown in FIG. 4A, and by reference number 415, the vehicle 110 and/or the ECU 112 may obtain sensor data and/or point data collected by the radar scanner 245 and/or the LIDAR scanner 250, among other examples. The sensor data may indicate one or more sensor detections (e.g., one or more radar detections and/or one or more LIDAR detections). For example, the ECU 112 may receive sensor data and/or point data from the radar scanner 245 and/or the LIDAR scanner 250. The sensor data may identify a plurality of points corresponding to one or more objects located in a physical environment of the vehicle 110. For example, the radar scanner 245 may send out one or more pulses of electromagnetic waves. The one or more pulses may be reflected by an object in a path of the one or more pulses. The reflection may be received by the radar scanner 245. The radar scanner 245 may determine one or more characteristics (e.g., an amplitude, a frequency, and/or the like) associated with the reflected pulses and may determine point data indicating a location of the object based on the one or more characteristics. The radar scanner 245 may provide the point data to the ECU 112 indicating a radar detection.

Additionally, or alternatively, the LIDAR scanner 250 may send out one or more pulses of light. The one or more pulses may be reflected by an object in a path of the one or more pulses. The reflection may be received by the LIDAR scanner 250. The LIDAR scanner 250 may determine one or more characteristics associated with the reflected pulses and may determine point data indicating a location of the object based on the one or more characteristics. The LIDAR scanner 250 may provide the point data to the ECU 112 indicating a LIDAR detection.

In some examples, the sensor data may include a sensor image (or frame) that includes a plurality of points (e.g., a point cloud), with each point indicating a signal reflected from that point and measurements of that point (e.g., location, velocity, SNR, and/or RCS). In some cases, the sensor image (or frame) may visually depict an intensity of electromagnetic reflections from objects in the environment. In some examples, the sensor image (or frame) may include a list of objects including attributes for each object, such as intensity, SNR, length, width, and/or yaw, among other examples. In some examples, the sensor data may include multiple sensor images (or frames). The sensor image may be associated with a pixel size (or a voxel size for a 3D sensor image) or a grid size.

In some examples, a point cloud data may be a collection of individual points within the environment that identify a measured parameter of objects within the environment. In the example of a sensor fixed on a vehicle to perform object detection, the detected objects may include other vehicles, road signs, vegetation, building, pedestrians, and/or other objects. Each of these objects may be present within a sensor image and have an RCS value that identifies an intensity of the electromagnetic reflection that can be used to identify objects of interest. For example, different surfaces of objects may have a magnetic permeability and may absorb some of the electromagnetic waves to reduce the intensity of the reflection.

The sensor data may be associated with (e.g., may include) a set of frames and/or images (e.g., one or more frames collected over time). For example, a frame may be associated with a grid (e.g., having the pixel size or grid size associated with the sensor data). The grid may define a set of cells associated with the frame. For example, grid information may include information associated with a static fixed coordinate system and a vehicle fixed coordinate system. The static fixed coordinate system may remain unchanged for a time period during which the vehicle 110 travels along a route (e.g., for a time period beginning at a time when the vehicle 110 travels from an initial location of the vehicle 110 and ending at a time when the vehicle 110 reaches a destination, an ignition of the vehicle 110 is moved to an off position, and/or the vehicle 110 is shifted into park). In some aspects, the static fixed coordinate system includes an origin corresponding to an initial location of the vehicle 110 on a map and each axis of the fixed coordinate system may extend in a respective direction that is perpendicular to a direction in which each other axis extends. For example, the static fixed coordinate system may be in an East-North-Up (ENU) format and a first axis may be aligned in an east-west direction (e.g., a coordinate of the first axis increases in value as the vehicle 110 travels east and decreases in value as the vehicle 110 travels west), a second axis may be aligned in a north-south direction (e.g., a coordinate of the second axis increases in value as the vehicle 110 travels north and decreases in value as the vehicle 110 travels south), and/or a third axis may be aligned in an up-down direction (e.g., a coordinate of the third axis increases in value as the vehicle 110 travels upward (e.g., up a ramp of a parking garage) and decreases in value as the vehicle 110 travels downward). The ENU coordinate system is provided as an example, and multiple other coordinate systems may be similarly applicable as described herein.

In some aspects, the sensor data may include one or more sensor images and one or more bounding regions (e.g., a bounding box, a bounding ellipse, a bounding square, or other bounding region) that identify pixels (or voxels) in the one or more sensor images that correspond to respective objects. For example, the sensor data obtained by the ECU 112 and/or the vehicle 110 may include indications of one or more objects.

In some aspects, the sensor data may include near scan sensor data and/or far scan sensor data. “Near scan sensor data” may refer to data collected by sensors from objects or features that are relatively close to the sensor. In some aspects, near scan sensor data may be captured using a wider field of view (FOV). “Far scan sensor data” may refer to data collected from objects or features that are at a greater distance from the sensor. In some aspects, far scan sensor data may be captured using a narrower FOV (e.g., as compared to near scan sensor data). In some aspects, by using near scan sensor data, the operations described herein may be improved because the sensor data may be more accurate.

As shown by reference number 420, the ECU 112 and/or the vehicle 110 may detect a trigger event. In some aspects, the ECU 112 and/or the vehicle 110 may be configured with one or more trigger events. The trigger events may be associated with modifying and/or performing one or more pre-processing operations and/or one or more post-processing operations associated with machine learning-based object detections, as described in more detail elsewhere herein.

The trigger event may be based at least in part on the environment and/or the vehicle 110. For example, the trigger event may be based at least in part on a velocity associated with the vehicle 110. For example, the ECU 112 and/or the vehicle 110 may detect the trigger event based at least in part on detecting that a velocity of the vehicle 110 does not satisfy a velocity threshold. Additionally, or alternatively, the trigger event may be based at least in part on a sensor type or a sensor configuration associated with the sensor data. For example, the ECU 112 and/or the vehicle 110 may detect the trigger event based at least in part on a configuration or installation location of a sensor (e.g., the radar scanner 245 and/or the LIDAR scanner 250) on the vehicle 110. As another example, the ECU 112 and/or the vehicle 110 may detect the trigger event based at least in part on a type of sensor used by the vehicle 110 to obtain the sensor data.

Additionally, or alternatively, the ECU 112 and/or the vehicle 110 may detect the trigger event based at least in part on a vehicle type associated with the vehicle 110. For example, certain vehicles may be associated with sensor configuration that result in inaccurate machine learning-based object detections in certain scenarios, as described in more detail elsewhere herein. Therefore, the ECU 112 and/or the vehicle 110 may detect the trigger event based at least in part on a vehicle type associated with the vehicle 110 being included in one or more vehicle types associated with the one or more trigger events. Additionally, or alternatively, the ECU 112 and/or the vehicle 110 may detect the trigger event based at least in part on a quantity of objects detected in the environment. For example, the ECU 112 and/or the vehicle 110 may detect the trigger event based at least in part on detecting that the quantity of objects detected in the environment satisfies an object threshold.

For example, the ECU 112 and/or the vehicle 110 may detect the trigger event based at least in part on detecting that the vehicle 110 is associated with a certain scenario, such as a stop-and-go traffic scenario. For example, the ECU 112 and/or the vehicle 110 may detect that the vehicle is associated with a stop-and-go traffic scenario based at least in part on detecting that a velocity of the vehicle 110 does not satisfy the velocity threshold and based at least in part on detecting that a quantity of objects detected in the environment satisfies the object threshold. This may indicate that the vehicle 110 is frequently stopping and starting motion because of a high quantity of other vehicles in the environment of the vehicle 110 (e.g., because of traffic around the vehicle 110).

As shown by reference number 425, the ECU 112 and/or the vehicle 110 may modify pre-processing and/or post-processing of the sensor data based on detecting the trigger event. For example, the performance of one or more pre-processing operations and/or one or more post-processing operations described herein may be conditioned on the detection of a trigger event. In other words, if the ECU 112 and/or the vehicle 110 does not detect a trigger event, then the ECU 112 and/or the vehicle 110 may refrain from performing one or more pre-processing operations and/or one or more post-processing operations described herein. This conserves processing resources and/or computing resources that would have otherwise been used performing the one or more pre-processing operations and/or the one or more post-processing operations in scenarios where the operation(s) may not be beneficial and/or may degrade an output of the deep learning model 410.

In some aspects, the ECU 112 and/or the vehicle 110 may modify one or more pre-processing operations associated with the sensor data for input to the deep learning model 410. Additionally, or alternatively, the ECU 112 and/or the vehicle 110 may modify one or more post-processing operations associated with an object detection output of the deep learning model 410. As used herein, “modifying” an operation (e.g., a pre-processing operation and/or a post-processing operation) may include changing the operation (e.g., changing one or more steps of the operation), performing the operation that would otherwise not have been performed, and/or refraining from performing the operation (or one or more steps of the operation), among other examples.

Additionally, or alternatively, the ECU 112 and/or the vehicle 110 may perform one or more (or all) of the pre-processing operations associated with the sensor data for input to the deep learning model 410 and/or the post-processing operations associated with an object detection output of the deep learning model 410 regardless of whether a trigger event is detected. In other words, some (or all) of the pre-processing operations and/or the post-processing operations may be performed by the ECU 112 and/or the vehicle 110 even if a trigger event is not detected. For example, some (or all) of the pre-processing operations and/or the post-processing operations described herein may be performed by the ECU 112 and/or the vehicle 110 as “default” operations (e.g., always performed by the ECU 112 and/or the vehicle 110).

In some aspects, modifying the one or more pre-processing operations may include causing the one or more pre-processing operations to include mapping points from at least one sensor image (e.g., having a first pixel size or a first grid size) to a grid having a second pixel size or a second grid size. For example, based at least in part on detecting the trigger event, the ECU 112 and/or the vehicle 110 may modify a pixel size and/or a grid size for inputs to the deep learning model 410. In some aspects, the ECU 112 and/or the vehicle 110 may increase a pixel size and/or a grid size for inputs to the deep learning model 410. In some aspects, the ECU 112 and/or the vehicle 110 may modify the pixel size and/or the grid size for inputs to the deep learning model 410 by a factor. For example, the ECU 112 and/or the vehicle 110 may modify the pixel size by a value of M, where M is a value greater than 1. As an example, M may be 3 (e.g., the ECU 112 and/or the vehicle 110 may triple the pixel size and/or the grid size for inputs to the deep learning model 410). As described elsewhere herein, the ECU 112 and/or the vehicle 110 may adaptively modify the pixel size and/or the grid size for inputs to the deep learning model 410 based at least in part on whether a trigger event is detected. For example, if a trigger event is not detected, then the ECU 112 and/or the vehicle 110 may use a first pixel size and/or a first grid size for inputs to the deep learning model 410 (e.g., a smaller pixel size and/or a smaller grid size to improve the lateral accuracy of object detections). If a trigger event is detected, then the ECU 112 and/or the vehicle 110 may use a second pixel size and/or a second grid size for inputs to the deep learning model 410 (e.g., a larger pixel size and/or a larger grid size to improve accuracy of object detections in scenarios associated with the trigger event).

Additionally, or alternatively, the ECU 112 and/or the vehicle 110 may modify the one or more post-processing operations to determine one or more property values associated with detected objects that are not indicated by the sensor data. For example, the sensor data may include one or more object detections (e.g., a bounding region indicating an object may be included in a sensor image or a sensor frame). In some aspects, the deep learning model 410 may detect an object that is not indicated by the sensor data (e.g., because of the improved accuracy of object detections caused by the modified pre-processing operations described herein). As described elsewhere herein, a sensor system (e.g., a radar system) may track data (referred to as tracked data) by measuring an object at different times, such as by sending electromagnetic signals at two different times and identifying differences in the reflected signals. In some examples, the tracked data from a sensory system may include velocity, acceleration, yaw, and/or other data. In such examples, there may be no tracked data associated with the objected that is detected by the deep learning model 410, but not detected by the sensor. Therefore, the ECU 112 and/or the vehicle 110 may modify the one or more post-processing operations to determine one or more property values associated with such detected objects.

Additionally, or alternatively, the ECU 112 and/or the vehicle 110 may modify the one or more post-processing operations to modify a classification confidence score of an object detection output for objects that are detected by the deep learning model 410 and that are not indicated by the sensor data. For example, the classification confidence score may indicate a confidence level of an object detection. In some aspects, based at least in part on detecting the trigger event, the ECU 112 and/or the vehicle 110 may modify the one or more post-processing operations to modify a classification confidence score of an object detection output for objects that are detected by the deep learning model 410 and that are not indicated by the sensor data. In some aspects, based at least in part on detecting the trigger event, the ECU 112 and/or the vehicle 110 may modify the one or more post-processing operations to increase a classification confidence score of an object detection output for objects that are detected by the deep learning model 410 and that are not indicated by the sensor data. For example, the ECU 112 and/or the vehicle 110 may increase the classification confidence score of such object detections by a fixed amount, by a percentage of an original classification confidence score, and/or by another amount.

Additionally, or alternatively, the ECU 112 and/or the vehicle 110 may modify the one or more post-processing operations to remove or exclude object detections indicated by the deep learning model 410 that at least partially overlap with a front end of the vehicle 110. For example, in some cases, the sensor data may include interference near the front end of the vehicle 110 that results in the deep learning model 410 incorrectly detecting the interference as an object. For example, a back side of a bounding region may have a longitudinal coordinate location having a negative value with respect to the front end of the vehicle 110 (e.g., where a lateral coordinate location of the bounding region is included in a width of the vehicle 110). In such cases, the ECU 112 and/or the vehicle 110 may modify the one or more post-processing operations to remove or exclude such object detections. For example, the ECU 112 and/or the vehicle 110 may modify the one or more post-processing operations to decrease (e.g., to zero or another low value) a classification confidence score of such object detections.

As shown by reference number 430, the vehicle 110 and/or the ECU 112 may perform pre-processing of the sensor data. For example, the vehicle 110 and/or the ECU 112 may perform one or more pre-processing operations associated with the sensor data to generate pre-processed sensor data. In some aspects, the vehicle 110 and/or the ECU 112 may perform one or more pre-processing operations based at least in part on detecting the trigger event.

For example, as shown by reference number 435, the one or more pre-processing operations may include modifying a pixel size (or a grid size or a voxel size) used for data that is to be input to the deep learning model 410. For example, the vehicle 110 and/or the ECU 112 may increase a grid size or a pixel size used for inputs to the deep learning model 410. As shown by reference number 440, the vehicle 110 and/or the ECU 112 may map points from one or more sensor image to a grid having a second (e.g., different) pixel size or grid size. For example, as described elsewhere herein, the vehicle 110 and/or the ECU 112 may use a larger grid size or pixel size in some scenarios, such as in stop-and-go traffic scenarios. Therefore, the vehicle 110 and/or the ECU 112 may map point clouds and/or data points indicated by the sensor data (e.g., in one or more sensor images or frames) to a grid having a modified (e.g., larger) pixel size or grid size to generate pre-processed sensor data.

In some aspects, a pre-processing operation may include determining a lateral velocity associated with one or more objects and/or with one or more data points. The vehicle 110 and/or the ECU 112 may provide, as a feature of the input to the deep learning model 410, the lateral velocity or a combination of the lateral velocity and a longitudinal velocity associated with the with one or more objects and/or with one or more data points. For example, the vehicle 110 and/or the ECU 112 may provide, as a feature of the input to the deep learning model 410, the lateral velocity from objects as a separate feature. As another example, the vehicle 110 and/or the ECU 112 may provide, as a feature of the input to the deep learning model 410, a combination of a lateral velocity and a longitudinal velocity as a single feature. The vehicle 110 and/or the ECU 112 may combine the lateral velocity and the longitudinal velocity using a squared root sum, an Li norm (e.g., a sum of the magnitudes of vectors of the respective velocities), and/or another summation technique.

As shown by reference number 445, the object detector 405 may provide, to the deep learning model 410, the pre-processed sensor data as an input. For example, the object detector 405 may provide, to the deep learning model 410, one or more frames of sensor data having the modified (e.g., larger) grid size. In some aspects, the pre-processed sensor data may include an indication of one or more property values of objects and/or point clouds indicated by the pre-processed sensor data. For example, the one or more property values may include instantaneous data, tracked data, or a combination of instantaneous data and tracked data, as described in more detail elsewhere herein.

As shown by reference number 450, the deep learning model 410 may provide, and the object detector 405 may obtain, an output of the deep learning model. For example, the output may include one or more inferences or predictions. For example, the output may include an object detection output. The object detection output may include an indication of a detection of one or more objects. For example, the output of the deep learning model 410 may include bounding regions associated with respective objects detected by the deep learning model 410. In some aspects, the output of the deep learning model 410 may include a probability of a class of occupancy status for the respective objects detected by the deep learning model 410. In some aspects, the output of the deep learning model 410 may include classification confidence scores for the respective objects detected by the deep learning model 410.

As shown in FIG. 4B, and by reference number 455, the vehicle 110 and/or the ECU 112 (and/or the object detector 405) may perform post-processing of the output of the deep learning model 410. For example, the vehicle 110 and/or the ECU 112 may perform one or more post-processing operations using the object detection output of the deep learning model 410. In some aspects, the vehicle 110 and/or the ECU 112 may perform one or more post-processing operations based at least in part on detecting the trigger event, as described in more detail elsewhere herein.

In some aspects, the vehicle 110 and/or the ECU 112 may determine, based on modifying the one or more post-processing operations, one or more property values associated with objects (e.g., that are indicated by the output of the deep learning model 410 but are not indicated by the sensor data) based at least in part on property values of point cloud data associated with a location of the object(s) as indicated by the sensor data and/or property values of one or more other objects indicated by the sensor data. For example, the vehicle 110 and/or the ECU 112 may determine the one or more property values using a combination of information associated with point clouds and tracked objects (e.g., tracked objects indicated by the sensor data). The one or more property values may include tracked data, such as velocity (e.g., a relative velocity and/or an absolute velocity), acceleration, yaw, and/or other tracked data.

In some aspects, the vehicle 110 and/or the ECU 112 may determine an absolute velocity of an object that is indicated by the output of the deep learning model 410 but is not indicated by the sensor data. The vehicle 110 and/or the ECU 112 may determine the absolute velocity based at least in part on a relative velocity of a point cloud indicated by the sensor data in a location that is indicated by a bounding region output by the deep learning model 410. For example, the bounding region may indicate a location associated with the detected object. The location may be associated with a point cloud of the sensor data. The vehicle 110 and/or the ECU 112 may determine a tracked property value of the object based at least in part on an instantaneous property value of the point cloud. For example, the vehicle 110 and/or the ECU 112 may determine an absolute velocity of the object based at least in part on a relative velocity of the point cloud.

In some aspects, the vehicle 110 and/or the ECU 112 may determine the absolute velocity of the object based at least in part on a relative velocity of the point cloud data associated with the location and an ego velocity. “Ego velocity” may refer to a velocity of the vehicle 110. For example, the vehicle 110 and/or the ECU 112 may project or combine a radial velocity with a lateral velocity and a longitudinal velocity of the point cloud. The vehicle 110 and/or the ECU 112 may combine the combined or projected radial velocity with a lateral velocity and a longitudinal velocity of the point cloud with the ego velocity of the vehicle 110 to determine the absolute velocity of the object. In other words, for an absolute velocity computation, radial velocity may be projected on lateral and longitudinal velocity (e.g., of the point cloud) and may be added with an ego velocity (e.g., of the vehicle 110 from a vehicle sensor). The vehicle 110 and/or the ECU 112 may determine other tracked data of the object (e.g., acceleration, yaw, or other tracked data) in a similar manner (e.g., using a combination of point cloud data, other tracked object data, and/or data associated with the vehicle 110).

Additionally, or alternatively, the one or more post-processing operations may include modifying a classification confidence score of the object detection output based on an object being indicated by the output of the deep learning model 410 and not indicated by the sensor data. For example, the object detection output of the deep learning model 410 may include a bounding region that identifies a location of an object. The location of the object may not be associated with an object indication as indicated by the sensor data. The one or more post-processing operations may include modifying a classification confidence score of the object. For example, the vehicle 110 and/or the ECU 112 may increase the classification confidence score of the detection of the object. In some aspects, the vehicle 110 and/or the ECU 112 may modify (e.g., increase) the classification confidence score of the detection of the object based at least in part on detecting a trigger event, as described in more detail elsewhere herein. Modifying (e.g., increasing) the classification confidence score may mitigate a risk of false positives output by the deep learning model 410. For example, the confidence level of object detections may only be increased for object detections that were previously associated with issues (e.g., objects detected by the deep learning model 410 and not the sensor data).

As shown by reference number 460, the vehicle 110 and/or the ECU 112 may perform one or more actions based at least in part on the post-processed output of the deep learning model 410. For example, the vehicle 110 and/or the ECU 112 may control the vehicle 110 according to post-processed output of the deep learning model 410 (e.g., causing the vehicle 110 to avoid areas associated with an object detection). The ECU 112 may perform an action (e.g., accelerating, decelerating, stopping, and/or changing lanes) associated with controlling the vehicle 110 based on location information associated with an object detection. In some aspects, the location information indicates a grid location associated with one or more of the cells included in output of the deep learning model 410. The ECU 112 may translate the grid information to an area of the physical environment corresponding to an area of the grid that includes the one or more cells associated with an object. In some aspects, the location information indicates an area of the physical environment that is occupied by one or more objects. The area of the physical environment may correspond to an area of the grid that includes the one or more cells associated with an undrivable occupancy status.

In some aspects, performing the action includes the ECU 112 indicating, via a user interface of the vehicle 110 and based at least in part on the location information, a location of the one or more cells associated with an undrivable occupancy status relative to a location of the vehicle 110. For example, the user interface may display a map of the physical environment of the vehicle 110. An origin of the grid may correspond to a current location of the vehicle 110. The ECU 112 may cause information associated with the one or more cells associated with an undrivable occupancy status (e.g., an icon and/or another type of information corresponding to a class of the one or more cells) to be displayed on the map at a location corresponding to a location of the one or more cells in the grid in conjunction with information associated with the current location of the vehicle 110.

As indicated above, FIGS. 4A and 4B are provided as an example. Other examples may differ from what is described with regard to FIGS. 4A and 4B.

FIG. 5 is a diagram of an example 500 associated with the deep learning model 410, in accordance with the present disclosure.

The deep learning model 410 may include an input layer 520 that is configured to ingest input data, such as pre-processed (scaled) sub-images that contain a target object for which detection is to be performed. In one example, the input layer 520 can include data representing the pixels of an input image or video frame. The deep learning model 410 may include one or more hidden layers 522a, 522b, through 522n. The hidden layers 522a, 522b, through 522n include n hidden layers, where n is an integer greater than or equal to one. The quantity of hidden layers can be made to include as many layers as needed for the given application. The deep learning model 410 may include an output layer 524 that provides an output resulting from the processing performed by the hidden layers 522a, 522b, through 522n. In one example, the output layer 524 may provide a classification for an object in an image or input video frame. The classification can include a class identifying the type of object (e.g., a person, a vehicle, a road sign, a dog, a cat, or other object).

The deep learning model 410 may be a multi-layer neural network (e.g., a DNN) of interconnected nodes. Each node may represent a piece of information. Information associated with the nodes is shared among the different layers and each layer retains information as information is processed. In some cases, the deep learning model 410 may include a feed-forward network, in which case there are no feedback connections where outputs of the network are fed back into itself. In some cases, the deep learning model 410 can include a recurrent neural network (RNN), which can have loops that allow information to be carried across nodes while reading in input.

Information can be exchanged between nodes through node-to-node interconnections between the various layers. Nodes of the input layer 520 can activate a set of nodes in the first hidden layer 522a. For example, as shown, each of the input nodes of the input layer 520 is connected to each of the nodes of the first hidden layer 522a. The nodes of the hidden layers 522a, 522b, through 522n can transform the information of each input node by applying activation functions to this information. The information derived from the transformation can then be passed to and can activate the nodes of the next hidden layer 522b, which can perform their own designated functions. Example functions include up-sampling, data transformation, and/or any other suitable functions. The output of the hidden layer 522b can then activate nodes of the next hidden layer, and so on. The output of the last hidden layer 522n can activate one or more nodes of the output layer 524, at which an output is provided. In some cases, while nodes (e.g., node 526) in the deep learning model 410 are shown as having multiple output lines, a node has a single output and all lines shown as being output from a node represent the same output value.

In some cases, each node or interconnection between nodes can have a weight that is a set of parameters derived from the training of the deep learning model 410. After the deep learning model 410 is trained, the deep learning model 410 may be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the deep learning model 410 to be adaptive to inputs and able to learn as more and more data is processed.

The deep learning model 410 can include any suitable deep network. One example includes a CNN, which includes an input layer and an output layer, with multiple hidden layers between the input and out layers. The hidden layers of a CNN include a series of convolutional, nonlinear, pooling (for downsampling), and fully connected layers. The deep learning model 410 can include any other deep network other than a CNN, such as an autoencoder, a deep belief network (DBN), and/or an RNNs, among other examples.

As indicated above, FIG. 5 is provided as an example. Other examples may differ from what is described with regard to FIG. 5.

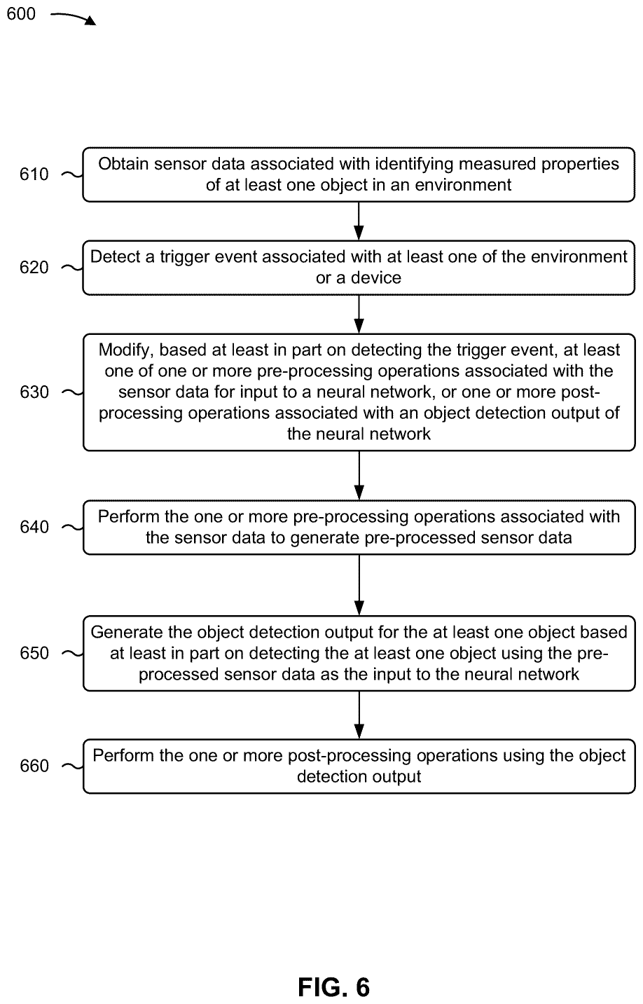

FIG. 6 is a flowchart of an example process 600 associated with processing for machine learning-based object detection using sensor data. In some aspects, one or more process blocks of FIG. 6 are performed by a device (e.g., the vehicle 110 and/or the ECU 112). In some aspects, one or more process blocks of FIG. 6 are performed by another device or a group of devices separate from or including the ECU 112, such as the server device 130 and/or the wireless communication device 120. Additionally, or alternatively, one or more process blocks of FIG. 6 may be performed by one or more components of device 200, such as processor 210, memory 215, storage component 220, input component 225, output component 230, communication interface 235, sensor(s) 240, radar scanner 245, and/or LIDAR scanner 250.

As shown in FIG. 6, process 600 may include obtaining sensor data associated with identifying measured properties of at least one object in an environment (block 610). For example, the device may obtain sensor data associated with identifying measured properties of at least one object in an environment, as described above.

As further shown in FIG. 6, process 600 may include detecting a trigger event associated with at least one of the environment or the device (block 620). For example, the device may detect a trigger event associated with at least one of the environment or the device, as described above.

As further shown in FIG. 6, process 600 may include modifying, based at least in part on detecting the trigger event, at least one of: one or more pre-processing operations associated with the sensor data for input to a neural network, or one or more post-processing operations associated with an object detection output of the neural network (block 630). For example, the device may modify, based at least in part on detecting the trigger event, at least one of: one or more pre-processing operations associated with the sensor data for input to a neural network, or one or more post-processing operations associated with an object detection output of the neural network, as described above.

As further shown in FIG. 6, process 600 may include performing the one or more pre-processing operations associated with the sensor data to generate pre-processed sensor data (block 640). For example, the device may perform the one or more pre-processing operations associated with the sensor data to generate pre-processed sensor data, as described above.

As further shown in FIG. 6, process 600 may include generating the object detection output for the at least one object based at least in part on detecting the at least one object using the pre-processed sensor data as the input to the neural network (block 650). For example, the device may generate the object detection output for the at least one object based at least in part on detecting the at least one object using the pre-processed sensor data as the input to the neural network, as described above.

As further shown in FIG. 6, process 600 may include performing the one or more post-processing operations using the object detection output (block 660). For example, the device may perform the one or more post-processing operations using the object detection output, as described above.

Process 600 may include additional implementations, such as any single implementation or any combination of implementations described below and/or in connection with one or more other processes described elsewhere herein.

In a first implementation, the sensor data includes at least one sensor image associated with a first pixel size, and modifying the one or more pre-processing operations includes causing the one or more pre-processing operations to include mapping points from the at least one sensor image to a grid having a second pixel size.

In a second implementation, alone or in combination with the first implementation, the second pixel size is greater than the first pixel size.

In a third implementation, alone or in combination with one or more of the first and second implementations, performing the one or more pre-processing operations includes mapping the points from the at least one sensor image to the grid having the second pixel size, and providing the grid as the input to the neural network.

In a fourth implementation, alone or in combination with one or more of the first through third implementations, the object detection output of the neural network includes a bounding region that identifies a location of the at least one object, the location of the at least one object is not associated with an object indication as indicated by the sensor data, and performing the one or more post-processing operations includes determining, based at least in part on modifying the one or more post-processing operations, one or more property values associated with the at least one object based at least in part on at least one of property values of point cloud data associated with the location as indicated by the sensor data or property values of one or more other objects indicated by the sensor data.

In a fifth implementation, alone or in combination with one or more of the first through fourth implementations, the one or more property values include at least one of an absolute velocity, or an acceleration.

In a sixth implementation, alone or in combination with one or more of the first through fifth implementations, determining the one or more property values associated with the at least one object includes determining an absolute velocity of the at least one object based at least in part on a relative velocity of the point cloud data associated with the location and an ego velocity.

In a seventh implementation, alone or in combination with one or more of the first through sixth implementations, the object detection output of the neural network includes a bounding region that identifies a location of the at least one object, the location of the at least one object is not associated with an object indication as indicated by the sensor data, and performing the one or more post-processing operations includes modifying, based at least in part on modifying the one or more post-processing operations, a classification confidence score of the object detection output based at least in part on the location of the at least one object not being associated with the object indication.

In an eighth implementation, alone or in combination with one or more of the first through seventh implementations, modifying the classification confidence score includes increasing the classification confidence score.

In a ninth implementation, alone or in combination with one or more of the first through eighth implementations, the trigger event is based at least in part on at least one of a velocity associated with the device, a sensor type or sensor configuration associated with the sensor data, a vehicle type associated with the device, or a quantity of objects detected in the environment.

In a tenth implementation, alone or in combination with one or more of the first through ninth implementations, performing the one or more pre-processing operations includes determining a lateral velocity associated with the at least one object, and providing, as a feature of the input to the neural network, the lateral velocity or a combination of the lateral velocity and a longitudinal velocity associated with the at least one object.

In an eleventh implementation, alone or in combination with one or more of the first through tenth implementations, the sensor data includes at least one point cloud from at least one sensor.

In a twelfth implementation, alone or in combination with one or more of the first through eleventh implementations, the sensor data includes at least one of radar data, LIDAR data, or camera data.

Although FIG. 6 shows example blocks of process 600, in some aspects, process 600 includes additional blocks, fewer blocks, different blocks, or differently arranged blocks than those depicted in FIG. 6. Additionally, or alternatively, two or more of the blocks of process 600 may be performed in parallel.

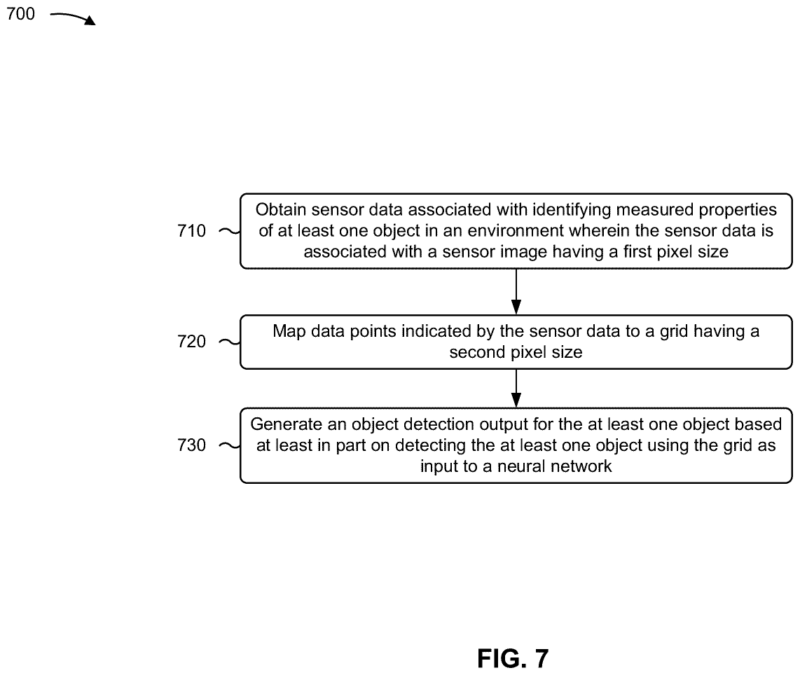

FIG. 7 is a flowchart of an example process 700 associated with processing for machine learning-based object detection using sensor data. In some aspects, one or more process blocks of FIG. 6 are performed by a device (e.g., the vehicle 110 and/or the ECU 112). In some aspects, one or more process blocks of FIG. 6 are performed by another device or a group of devices separate from or including the ecu 112, such as the server device 130 and/or the wireless communication device 120. Additionally, or alternatively, one or more process blocks of FIG. 7 may be performed by one or more components of device 200, such as processor 210, memory 215, storage component 220, input component 225, output component 230, communication interface 235, sensor(s) 240, radar scanner 245, and/or LIDAR scanner 250.

As shown in FIG. 7, process 700 may include obtaining sensor data associated with identifying measured properties of at least one object in an environment, wherein the sensor data is associated with a sensor image having a first pixel size (block 710). For example, the device may obtain sensor data associated with identifying measured properties of at least one object in an environment, wherein the sensor data is associated with a sensor image having a first pixel size, as described above. In some aspects, the sensor data is associated with a sensor image having a first pixel size.

As further shown in FIG. 7, process 700 may include mapping, by the device, data points indicated by the sensor data to a grid having a second pixel size (block 720). For example, the device may map data points indicated by the sensor data to a grid having a second pixel size, as described above.

As further shown in FIG. 7, process 700 may include generating an object detection output for the at least one object based at least in part on detecting the at least one object using the grid as input to a neural network (block 730). For example, the device may generate an object detection output for the at least one object based at least in part on detecting the at least one object using the grid as input to a neural network, as described above.

Process 700 may include additional implementations, such as any single implementation or any combination of implementations described below and/or in connection with one or more other processes described elsewhere herein.

In a first implementation, process 700 includes detecting a trigger event associated with at least one of the environment or the device, wherein mapping the data points indicated by the sensor data to the grid having the second pixel size is based at least in part on detecting the trigger event.

In a second implementation, alone or in combination with the first implementation, the trigger event is based at least in part on at least one of a velocity associated with the device, a sensor type or sensor configuration associated with the sensor data, a vehicle type associated with the device, or a quantity of objects detected in the environment.

In a third implementation, alone or in combination with one or more of the first and second implementations, the second pixel size is greater than the first pixel size.

In a fourth implementation, alone or in combination with one or more of the first through third implementations, process 700 includes performing one or more post-processing operations using the object detection output.

In a fifth implementation, alone or in combination with one or more of the first through fourth implementations, the object detection output of the neural network includes a bounding region that identifies a location of the at least one object, the location of the at least one object is not associated with an object indication as indicated by the sensor data, and performing the one or more post-processing operations includes determining one or more property values associated with the at least one object based at least in part on at least one of property values of point cloud data associated with the location as indicated by the sensor data or property values of one or more other objects indicated by the sensor data.

In a sixth implementation, alone or in combination with one or more of the first through fifth implementations, the one or more property values include at least one of an absolute velocity, or an acceleration.

In a seventh implementation, alone or in combination with one or more of the first through sixth implementations, determining the one or more property values associated with the at least one object includes determining an absolute velocity of the at least one object based at least in part on a relative velocity of the point cloud data associated with the location and an ego velocity.

In an eighth implementation, alone or in combination with one or more of the first through seventh implementations, the object detection output of the neural network includes a bounding region that identifies a location of the at least one object, the location of the at least one object is not associated with an object indication as indicated by the sensor data, and performing the one or more post-processing operations includes modifying a classification confidence score of the object detection output based at least in part on the location of the at least one object not being associated with the object indication.

In a ninth implementation, alone or in combination with one or more of the first through eighth implementations, the sensor data includes at least one of radar data, LIDAR data, or camera data.

Although FIG. 7 shows example blocks of process 700, in some aspects, process 700 includes additional blocks, fewer blocks, different blocks, or differently arranged blocks than those depicted in FIG. 7. Additionally, or alternatively, two or more of the blocks of process 700 may be performed in parallel.

The following provides an overview of some Aspects of the present disclosure:

Aspect 1: A method, comprising: obtaining, by a device, sensor data associated with identifying measured properties of at least one object in an environment; detecting, by the device, a trigger event associated with at least one of the environment or the device; modifying, by the device and based at least in part on detecting the trigger event, at least one of: one or more pre-processing operations associated with the sensor data for input to a neural network, or one or more post-processing operations associated with an object detection output of the neural network; performing, by the device, the one or more pre-processing operations associated with the sensor data to generate pre-processed sensor data; generating, by the device, the object detection output for the at least one object based at least in part on detecting the at least one object using the pre-processed sensor data as the input to the neural network; and performing, by the device, the one or more post-processing operations using the object detection output.

Aspect 2: The method of Aspect 1, wherein the sensor data includes at least one sensor image associated with a first pixel size, and wherein modifying the one or more pre-processing operations comprises: causing the one or more pre-processing operations to include mapping points from the at least one sensor image to a grid having a second pixel size.

Aspect 3: The method of Aspect 2, wherein the second pixel size is greater than the first pixel size.

Aspect 4: The method of any of Aspect 2-3, wherein performing the one or more pre-processing operations comprises: mapping the points from the at least one sensor image to the grid having the second pixel size; and providing the grid as the input to the neural network.

Aspect 5: The method of any of Aspects 1-4, wherein the object detection output of the neural network includes a bounding region that identifies a location of the at least one object, wherein the location of the at least one object is not associated with an object indication as indicated by the sensor data, and wherein performing the one or more post-processing operations comprises: determining, based at least in part on modifying the one or more post-processing operations, one or more property values associated with the at least one object based at least in part on at least one of property values of point cloud data associated with the location as indicated by the sensor data or property values of one or more other objects indicated by the sensor data.

Aspect 6: The method of Aspect 5, wherein the one or more property values include at least one of: an absolute velocity, or an acceleration.

Aspect 7: The method of any of Aspects 5-6, wherein determining the one or more property values associated with the at least one object comprises: determining an absolute velocity of the at least one object based at least in part on a relative velocity of the point cloud data associated with the location and an ego velocity.

Aspect 8: The method of any of Aspects 1-7, wherein the object detection output of the neural network includes a bounding region that identifies a location of the at least one object, wherein the location of the at least one object is not associated with an object indication as indicated by the sensor data, and wherein performing the one or more post-processing operations comprises: modifying, based at least in part on modifying the one or more post-processing operations, a classification confidence score of the object detection output based at least in part on the location of the at least one object not being associated with the object indication.

Aspect 9: The method of Aspect 8, wherein modifying the classification confidence score comprises: increasing the classification confidence score.

Aspect 10: The method of any of Aspects 1-9, wherein the trigger event is based at least in part on at least one of: a velocity associated with the device, a sensor type or sensor configuration associated with the sensor data, a vehicle type associated with the device, or a quantity of objects detected in the environment.

Aspect 11: The method of any of Aspects 1-10, wherein performing the one or more pre-processing operations comprises: determining a lateral velocity associated with the at least one object; and providing, as a feature of the input to the neural network, the lateral velocity or a combination of the lateral velocity and a longitudinal velocity associated with the at least one object.

Aspect 12: The method of any of Aspects 1-11, wherein the sensor data includes at least one point cloud from at least one sensor.

Aspect 13: The method of any of Aspects 1-12, wherein the sensor data includes at least one of radar data, light detection and ranging (LIDAR) data, or camera data.

Aspect 14: A method, comprising: obtaining, by a device, sensor data associated with identifying measured properties of at least one object in an environment, wherein the sensor data is associated with a sensor image having a first pixel size; mapping, by the device, data points indicated by the sensor data to a grid having a second pixel size; and generating, by the device, an object detection output for the at least one object based at least in part on detecting the at least one object using the grid as input to a neural network.

Aspect 15: The method of Aspect 14, further comprising: detecting a trigger event associated with at least one of the environment or the device, wherein mapping the data points indicated by the sensor data to the grid having the second pixel size is based at least in part on detecting the trigger event.

Aspect 16: The method of Aspect 15, wherein the trigger event is based at least in part on at least one of: a velocity associated with the device, a sensor type or sensor configuration associated with the sensor data, a vehicle type associated with the device, or a quantity of objects detected in the environment.

Aspect 17: The method of any of Aspects 14-16, wherein the second pixel size is greater than the first pixel size.

Aspect 18: The method of any of Aspects 14-17, further comprising: performing one or more post-processing operations using the object detection output.

Aspect 19: The method of Aspect 18, wherein the object detection output of the neural network includes a bounding region that identifies a location of the at least one object, wherein the location of the at least one object is not associated with an object indication as indicated by the sensor data, and wherein performing the one or more post-processing operations comprises: determining one or more property values associated with the at least one object based at least in part on at least one of property values of point cloud data associated with the location as indicated by the sensor data or property values of one or more other objects indicated by the sensor data.

Aspect 20: The method of Aspect 19, wherein the one or more property values include at least one of: an absolute velocity, or an acceleration.

Aspect 21: The method of any of Aspects 19-20, wherein determining the one or more property values associated with the at least one object comprises: determining an absolute velocity of the at least one object based at least in part on a relative velocity of the point cloud data associated with the location and an ego velocity.

Aspect 22: The method of any of Aspects 18-21, wherein the object detection output of the neural network includes a bounding region that identifies a location of the at least one object, wherein the location of the at least one object is not associated with an object indication as indicated by the sensor data, and wherein performing the one or more post-processing operations comprises: modifying a classification confidence score of the object detection output based at least in part on the location of the at least one object not being associated with the object indication.

Aspect 23: The method of any of Aspects 14-22, wherein the sensor data includes at least one of radar data, light detection and ranging (LIDAR) data, or camera data.

Aspect 24: A system configured to perform one or more operations recited in one or more of Aspects 1-13.

Aspect 25: An apparatus comprising means for performing one or more operations recited in one or more of Aspects 1-13.

Aspect 26: A non-transitory computer-readable medium storing a set of instructions, the set of instructions comprising one or more instructions that, when executed by a device, cause the device to perform one or more operations recited in one or more of Aspects 1-13.

Aspect 27: A computer program product comprising instructions or code for executing one or more operations recited in one or more of Aspects 1-13.

Aspect 28: A device comprising one or more memories and one or more processors, coupled to the one or more memories, configured to perform one or more operations recited in one or more of Aspects 1-13.

Aspect 29: A system configured to perform one or more operations recited in one or more of Aspects 14-23.

Aspect 30: An apparatus comprising means for performing one or more operations recited in one or more of Aspects 14-23.

Aspect 31: A non-transitory computer-readable medium storing a set of instructions, the set of instructions comprising one or more instructions that, when executed by a device, cause the device to perform one or more operations recited in one or more of Aspects 14-23.

Aspect 32: A computer program product comprising instructions or code for executing one or more operations recited in one or more of Aspects 14-23.

Aspect 33: A device comprising one or more memories and one or more processors, coupled to the one or more memories, configured to perform one or more operations recited in one or more of Aspects 14-23.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A device, comprising:
one or more memories; and
one or more processors, coupled to the one or more memories, configured to:
obtain sensor data associated with identifying measured properties of at least one object in an environment;
detect a trigger event associated with at least one of the environment or the device;
modify, based at least in part on detecting the trigger event, at least one of:
one or more pre-processing operations associated with the sensor data for input to a neural network, or
one or more post-processing operations associated with an object detection output of the neural network;
perform the one or more pre-processing operations associated with the sensor data to generate pre-processed sensor data;
generate the object detection output for the at least one object based at least in part on detecting the at least one object using the pre-processed sensor data as the input to the neural network; and
perform the one or more post-processing operations using the object detection output.

2. The device of claim 1, wherein the sensor data includes at least one sensor image associated with a first pixel size, and wherein the one or more processors, to modify the one or more pre-processing operations, are configured to:
cause the one or more pre-processing operations to include mapping points from the at least one sensor image to a grid having a second pixel size.

3. The device of claim 2, wherein the second pixel size is greater than the first pixel size.

4. The device of claim 2, wherein the one or more processors, to perform the one or more pre-processing operations, are configured to:
map the points from the at least one sensor image to the grid having the second pixel size; and
provide the grid as the input to the neural network.

5. The device of claim 1, wherein the object detection output of the neural network includes a bounding region that identifies a location of the at least one object, wherein the location of the at least one object is not associated with an object indication as indicated by the sensor data, and wherein the one or more processors, to perform the one or more post-processing operations, are configured to:
determine, based at least in part on modifying the one or more post-processing operations, one or more property values associated with the at least one object based at least in part on at least one of property values of point cloud data associated with the location as indicated by the sensor data or property values of one or more other objects indicated by the sensor data.

6. The device of claim 5, wherein the one or more property values include at least one of:
an absolute velocity, or
an acceleration.

7. The device of claim 5, wherein the one or more processors, to determine the one or more property values associated with the at least one object, are configured to:
determine an absolute velocity of the at least one object based at least in part on a relative velocity of the point cloud data associated with the location and an ego velocity.

8. The device of claim 1, wherein the object detection output of the neural network includes a bounding region that identifies a location of the at least one object, wherein the location of the at least one object is not associated with an object indication as indicated by the sensor data, and wherein the one or more processors, to perform the one or more post-processing operations, are configured to:
modify, based at least in part on modifying the one or more post-processing operations, a classification confidence score of the object detection output based at least in part on the location of the at least one object not being associated with the object indication.

9. The device of claim 1, wherein the trigger event is based at least in part on at least one of:
a velocity associated with the device,
a sensor type or sensor configuration associated with the sensor data,
a vehicle type associated with the device, or
a quantity of objects detected in the environment.

10. The device of claim 1, wherein the one or more processors, to perform the one or more pre-processing operations, are configured to:
determine a lateral velocity associated with the at least one object; and
provide, as a feature of the input to the neural network, the lateral velocity or a combination of the lateral velocity and a longitudinal velocity associated with the at least one object.

11. A device, comprising:
one or more memories; and
one or more processors, coupled to the one or more memories, configured to:
obtain sensor data associated with identifying measured properties of at least one object in an environment,
wherein the sensor data is associated with a sensor image having a first pixel size;
map data points indicated by the sensor data to a grid having a second pixel size; and
generate an object detection output for the at least one object based at least in part on detecting the at least one object using the grid as input to a neural network.

12. The device of claim 11, wherein the one or more processors are further configured to:
detect a trigger event associated with at least one of the environment or the device, wherein mapping the data points indicated by the sensor data to the grid having the second pixel size is based at least in part on detecting the trigger event.

13. The device of claim 12, wherein the trigger event is based at least in part on at least one of:
a velocity associated with the device,
a sensor type or sensor configuration associated with the sensor data,
a vehicle type associated with the device, or
a quantity of objects detected in the environment.

14. The device of claim 11, wherein the second pixel size is greater than the first pixel size.

15. The device of claim 11, wherein the one or more processors are further configured to:
perform one or more post-processing operations using the object detection output.

16. The device of claim 15, wherein the object detection output of the neural network includes a bounding region that identifies a location of the at least one object, wherein the location of the at least one object is not associated with an object indication as indicated by the sensor data, and wherein the one or more processors, to perform the one or more post-processing operations, are configured to:
determine one or more property values associated with the at least one object based at least in part on at least one of property values of point cloud data associated with the location as indicated by the sensor data or property values of one or more other objects indicated by the sensor data.

17. The device of claim 16, wherein the one or more property values include at least one of:
an absolute velocity, or
an acceleration.

18. The device of claim 16, wherein the one or more processors, to determine the one or more property values associated with the at least one object, are configured to:
determine an absolute velocity of the at least one object based at least in part on a relative velocity of the point cloud data associated with the location and an ego velocity.

19. The device of claim 16, wherein the one or more processors, to perform the one or more post-processing operations, are configured to:
modify a classification confidence score of the object detection output based at least in part on the location of the at least one object not being associated with the object indication.

20. A method, comprising:
obtaining, by a device, sensor data associated with identifying measured properties of at least one object in an environment;
detecting, by the device, a trigger event associated with at least one of the environment or the device;
modifying, by the device and based at least in part on detecting the trigger event, at least one of:
one or more pre-processing operations associated with the sensor data for input to a neural network, or
one or more post-processing operations associated with an object detection output of the neural network;
performing, by the device, the one or more pre-processing operations associated with the sensor data to generate pre-processed sensor data;
generating, by the device, the object detection output for the at least one object based at least in part on detecting the at least one object using the pre-processed sensor data as the input to the neural network; and
performing, by the device, the one or more post-processing operations using the object detection output.

21. The method of claim 20, wherein the sensor data includes at least one sensor image associated with a first pixel size, and wherein modifying the one or more pre-processing operations comprises:
causing the one or more pre-processing operations to include mapping points from the at least one sensor image to a grid having a second pixel size.

22. The method of claim 21, wherein the second pixel size is greater than the first pixel size.

23. The method of claim 21, wherein performing the one or more pre-processing operations comprises:
mapping the points from the at least one sensor image to the grid having the second pixel size; and
providing the grid as the input to the neural network.

24. The method of claim 20, wherein the object detection output of the neural network includes a bounding region that identifies a location of the at least one object, wherein the location of the at least one object is not associated with an object indication as indicated by the sensor data, and wherein performing the one or more post-processing operations comprises:
determining, based at least in part on modifying the one or more post-processing operations, one or more property values associated with the at least one object based at least in part on at least one of property values of point cloud data associated with the location as indicated by the sensor data or property values of one or more other objects indicated by the sensor data.

25. The method of claim 24, wherein determining the one or more property values associated with the at least one object comprises:
determining an absolute velocity of the at least one object based at least in part on a relative velocity of the point cloud data associated with the location and an ego velocity.

26. A method, comprising:
obtaining, by a device, sensor data associated with identifying measured properties of at least one object in an environment,
wherein the sensor data is associated with a sensor image having a first pixel size;
mapping, by the device, data points indicated by the sensor data to a grid having a second pixel size; and
generating, by the device, an object detection output for the at least one object based at least in part on detecting the at least one object using the grid as input to a neural network.

27. The method of claim 26, further comprising:
detecting a trigger event associated with at least one of the environment or the device, wherein mapping the data points indicated by the sensor data to the grid having the second pixel size is based at least in part on detecting the trigger event.

28. The method of claim 26, further comprising:
performing one or more post-processing operations using the object detection output.

29. The method of claim 28, wherein the object detection output of the neural network includes a bounding region that identifies a location of the at least one object, wherein the location of the at least one object is not associated with an object indication as indicated by the sensor data, and wherein performing the one or more post-processing operations comprises:
determining one or more property values associated with the at least one object based at least in part on at least one of property values of point cloud data associated with the location as indicated by the sensor data or property values of one or more other objects indicated by the sensor data.

30. The method of claim 28, wherein the object detection output of the neural network includes a bounding region that identifies a location of the at least one object, wherein the location of the at least one object is not associated with an object indication as indicated by the sensor data, and wherein performing the one or more post-processing operations comprises:
modifying a classification confidence score of the object detection output based at least in part on the location of the at least one object not being associated with the object indication.
